(19) United States
(12) Patent Application Publication
(10) Pub. No.: US 2026/0278910 A1
(43) Pub. Date: Sep. 17, 2026

(54) MULTI-RENDERER AND COMPUTATION DATA IN SCENE DESCRIPTION

(71) Applicant: InterDigital CE Patent Holdings, SAS, Paris (FR)

(72) Inventors: Patrice Hirtzlin, Betton (FR); Pierrick Jouet, Rennes (FR); Sylvain Lelievre, Montgermont (FR); Etienne Faivre d'Arcier, Saint Gonlay (FR); Loic Fontaine, Noyal sur Vilaine (FR)

(21) Appl. No.: 19/473,042

(22) PCT Filed: Mar. 27, 2024
(86) PCT No.: PCT/EP2024/058239

§ 371 Date: Oct. 6, 2025

(30) Foreign Application Priority Data
Apr. 7, 2023 (EP) 23305514.4

(51) Int. Cl. G06T 15/00

(52) U.S. Cl. CPC G06T 15/005; G06T 2210/32; G06T 2210/61

(57) ABSTRACT

Some embodiments of a method may include obtaining information indicating interaction with one or more handlers used in handling a three-dimensional (3D) scene. For some embodiments, the method may further include identifying handler data, object data, and component data associated with at least one respective handler of the one or more handlers used. Some embodiments of the method may further include responsive to determining handler data is global scene data, adding, at a scene-level, handler data to a dedicated structure for the respective handler. For some embodiments, the method may further include adding, at a node-level, for at least one node associated with the respective handler, object data to the dedicated structure for the respective handler. Some embodiments of the method may further include adding, at a component-level, for at least one component associated with the respective node, component data to the dedicated structure for the respective handler.

### CROSS-REFERENCE TO RELATED APPLICATIONS

This application claims benefit of European Patent Application No. EP23305514, filed Apr. 7, 2023, entitled “MULTI-RENDERER AND COMPUTATION DATA IN SCENE DESCRIPTION,” which is hereby incorporated by reference in its entirety.

### BACKGROUND

Extended reality (XR) is a technology enabling interactive experiences where the real-world environment and/or a video content is enhanced by virtual content, which can be defined across multiple sensory modalities, including visual, auditory, haptic, etc. During runtime of the application, the virtual content (3D content or audio/video file for example) is rendered in real-time in a way which is consistent with the user context (environment, point of view, device, etc.). Scene graphs (such as the one proposed by Khronos/gITF and its extensions defined in MPEG Scene Description format or Apple/USDZ for instance) are a possible way to represent the content to be rendered. They combine a declarative description of the scene structure linking real-environment objects and virtual objects on one hand, and binary representations of the virtual content on the other hand.

Although such scene description frameworks ensure that the timed media and the corresponding relevant virtual content are available at any time during the rendering of the application, such frameworks do not provide a description of how a user can interact with the scene objects at runtime for immersive XR experiences. Hence, there is no support of user specific XR experiences for consuming the immersive media.

### SUMMARY

A first example method in accordance with some embodiments may include: obtaining information indicating interaction with one or more renderers used in rendering a three-dimensional (3D) scene; identifying renderer data, object data, and component data associated with at least one respective renderer of the one or more renderers used; responsive to determining renderer data is global scene data, adding, at a scene-level, renderer data to a dedicated structure for the respective renderer; adding, at a node-level, for at least one node associated with the respective renderer, object data to the dedicated structure for the respective renderer; and adding, at a component-level, for at least one component associated with the respective node, component data to the dedicated structure for the respective renderer.

For some embodiments of the first example method, the one or more renderers are selected from the group consisting of video-related renderers, audio-related renderers, and haptic-related renderers.

For some embodiments of the first example method, the one or more renderers are selected from the group consisting of video-related renderers, audio-related renderers, haptic-related renderers, geometric-related renderers, texture-related renderers, camera-related renderers, animation-related renderers, physics-related renderers, and lighting-related renderers.

For some embodiments of the first example method, at least two renderers are used in rendering the 3D scene, and at least two categories of renderers are selected from the group consisting of video-related renderers, audio-related renderers, haptic-related renderers, geometric-related renderers, texture-related renderers, camera-related renderers, animation-related renderers, physics-related renderers, and lighting-related renderers.

For some embodiments of the first example method, at least one of the dedicated structures is compatible with a gITF format.

For some embodiments of the first example method, at least one of the dedicated structures is compatible with an MPEG-I Scene Description format.

For some embodiments of the first example method, the dedicated structures are stored in a single file.

For some embodiments of the first example method, the renderer data includes functionality support information.

For some embodiments of the first example method, the functionality support information includes renderer functionality needed to render at least one component of an object.

For some embodiments of the first example method, the component data for at least one component includes information indicating an ability to render the scene in a degraded mode without rendering the at least one component.

A first example apparatus in accordance with some embodiments may include: a processor; and a non-transitory computer-readable medium storing instructions operative, when executed by the processor, to cause the apparatus to perform any of the methods listed above.

A second example method in accordance with some embodiments may include: obtaining information indicating interaction with one or more renderers used in rendering a three-dimensional (3D) scene; identifying renderer data, object data, and component data associated with at least one respective renderer of the one or more renderers used; obtaining, at a scene-level, renderer data from a dedicated structure for the respective renderer; obtaining, at a node-level, for at least one node associated with the respective renderer, object data from the dedicated structure for the respective renderer; obtaining, at a component-level, for at least one component associated with the respective node, component data from the dedicated structure for the respective renderer; and determining renderer support for the respective renderer.

For some embodiments of the second example method, determining renderer support includes: verifying user equipment (UE) supports the respective renderer; obtaining rendering data associated with the respective renderer; and rendering at least one component associated with the rendering data.

For some embodiments of the second example method, determining renderer support includes: determining user equipment (UE) lacks support for the respective renderer; sending, to an edge server, rendering data associated with the respective renderer; and verifying the edge server accepted delegation of the rendering data.

For some embodiments of the second example method, determining renderer support includes: determining user equipment (UE) lacks support for the respective renderer; sending, to an edge server, rendering data associated with the respective renderer; determining the edge server declined delegation of the rendering data; and responsive to determining rendering of the rendering data is not required, continuing to use the 3D scene without rendering the rendering data.

For some embodiments of the second example method, determining renderer support includes: determining user equipment (UE) lacks support for the respective renderer; sending, to an edge server, rendering data associated with the respective renderer; determining the edge server declined delegation of the rendering data; and responsive to determining rendering of the rendering data is required, generating an error message; and stopping use of the 3D scene without rendering the rendering data.

For some embodiments of the second example method, the one or more renderers are selected from the group consisting of video-related renderers, audio-related renderers, and haptic-related renderers.

For some embodiments of the second example method, the one or more renderers are selected from the group consisting of video-related renderers, audio-related renderers, haptic-related renderers, geometric-related renderers, texture-related renderers, camera-related renderers, animation-related renderers, physics-related renderers, and lighting-related renderers.

For some embodiments of the second example method, at least two renderers are used in rendering the 3D scene, and at least two categories of renderers are selected from the group consisting of video-related renderers, audio-related renderers, haptic-related renderers, geometric-related renderers, texture-related renderers, camera-related renderers, animation-related renderers, physics-related renderers, and lighting-related renderers.

For some embodiments of the second example method, at least one of the dedicated structures is compatible with a gITF format.

For some embodiments of the second example method, at least one of the dedicated structures is compatible with an MPEG-I Scene Description format.

For some embodiments of the second example method, the dedicated structures are stored in a single file.

A second example apparatus in accordance with some embodiments may include: a processor; and a non-transitory computer-readable medium storing instructions operative, when executed by the processor, to cause the apparatus to perform any of the methods listed above.

A third example method in accordance with some embodiments may include: obtaining information indicating interaction with one or more computation blocks used in generating a three-dimensional (3D) scene; identifying computation block data, object data, and component data associated with at least one respective computation block of the one or more computation blocks used; responsive to determining computation block data is global scene data, adding, at a scene-level, computation block data to a dedicated structure for the respective computation block; adding, at a node-level, for at least one node associated with the respective computation block, object data to the dedicated structure for the respective computation block; and adding, at a component-level, for at least one component associated with the respective node, component data to the dedicated structure for the respective computation block.

For some embodiments of the third example method, the one or more computation blocks are selected from the group consisting of video-related computation blocks, audio-related computation blocks, haptic-related computation blocks, geometric-related computation blocks, texture-related computation blocks, camera-related computation blocks, animation-related computation blocks, physics-related computation blocks, and lighting-related computation blocks.

For some embodiments of the third example method, at least two computation blocks are used in performing a computation related to the 3D scene, and at least two categories of computation blocks are selected from the group consisting of video-related computation blocks, audio-related computation blocks, haptic-related computation blocks, geometric-related computation blocks, texture-related computation blocks, camera-related computation blocks, animation-related computation blocks, physics-related computation blocks, and lighting-related computation blocks.

For some embodiments of the third example method, at least one of the dedicated structures is compatible with a gITF format.

For some embodiments of the third example method, at least one of the dedicated structures is compatible with an MPEG-I Scene Description format.

For some embodiments of the third example method, the dedicated structures are stored in a single file.

For some embodiments of the third example method, the computation block data includes functionality support information.

For some embodiments of the third example method, the functionality support information includes computation block functionality needed to perform a calculation for at least one component of an object.

For some embodiments of the third example method, the component data for at least one component includes information indicating an ability to generate the scene in a degraded mode without performing a calculation related to the at least one component.

A third example apparatus in accordance with some embodiments may include: a processor; and a non-transitory computer-readable medium storing instructions operative, when executed by the processor, to cause the apparatus to perform any of the methods listed above.

A fourth example method in accordance with some embodiments may include: obtaining information indicating interaction with one or more computation blocks used in generating a three-dimensional (3D) scene; identifying computation block data, object data, and component data associated with at least one respective computation block of the one or more computation blocks used; obtaining, at a scene-level, computation block data from a dedicated structure for the respective computation block; obtaining, at a node-level, for at least one node associated with the respective computation block, object data from the dedicated structure for the respective computation block; obtaining, at a component-level, for at least one component associated with the respective node, component data from the dedicated structure for the respective computation block; and determining computation block support for the respective computation block.

For some embodiments of the fourth example method, determining computation block support includes: verifying user equipment (UE) supports the respective computation block; obtaining computation block data associated with the respective computation block; and computing a calculation related to at least one component associated with the computation block data.

For some embodiments of the fourth example method, determining computation block support includes: determining user equipment (UE) lacks support for the respective computation block; sending, to an edge server, computation block data associated with the respective computation block; and verifying the edge server accepted delegation of the computation block data.

For some embodiments of the fourth example method, determining computation block support includes: determining user equipment (UE) lacks support for the respective computation block; sending, to an edge server, computation block data associated with the respective computation block; determining the edge server declined delegation of the computation block data; and responsive to determining performing a calculation related to the computation block data is not required, continuing to use the 3D scene without performing the calculation related to a component.

For some embodiments of the fourth example method, determining computation block support includes: determining user equipment (UE) lacks support for the respective computation block; sending, to an edge server, computation block data associated with the respective computation block; determining the edge server declined delegation of the computation block data; and responsive to determining computation of the computation block data is required, generating an error message; and stopping use of the 3D scene without performing the calculation related to a component.

For some embodiments of the fourth example method, the one or more computation blocks are selected from the group consisting of video-related computation blocks, audio-related computation blocks, haptic-related computation blocks, geometric-related computation blocks, texture-related computation blocks, camera-related computation blocks, animation-related computation blocks, physics-related computation blocks, and lighting-related computation blocks.

For some embodiments of the fourth example method, at least two computation blocks are used in generating the 3D scene, and at least two categories of computation blocks are selected from the group consisting of video-related computation blocks, audio-related computation blocks, haptic-related computation blocks, geometric-related computation blocks, texture-related computation blocks, camera-related computation blocks, animation-related computation blocks, physics-related computation blocks, and lighting-related computation blocks.

For some embodiments of the fourth example method, at least one of the dedicated structures is compatible with a gITF format.

For some embodiments of the fourth example method, at least one of the dedicated structures is compatible with an MPEG-I Scene Description format.

For some embodiments of the fourth example method, the dedicated structures are stored in a single file.

For some embodiments of the fourth example method, the single file includes two or more versions of object data.

For some embodiments of the fourth example method, the single file includes two or more versions of component data.

For some embodiments of the fourth example method, at least two computation blocks are used in generating the 3D scene, first and second categories of computation blocks are selected from the group consisting of video-related computation blocks, audio-related computation blocks, haptic-related computation blocks, geometric-related computation blocks, texture-related computation blocks, camera-related computation blocks, animation-related computation blocks, physics-related computation blocks, and lighting-related computation blocks, the first category is different from the second category, the single file includes first and second versions of object data, the first version of the object data is associated with the first category of computation blocks, and the second version of the object data is associated with the second category of computation blocks.

For some embodiments of the fourth example method, at least two computation blocks are used in generating the 3D scene, first and second categories of computation blocks are selected from the group consisting of video-related computation blocks, audio-related computation blocks, haptic-related computation blocks, geometric-related computation blocks, texture-related computation blocks, camera-related computation blocks, animation-related computation blocks, physics-related computation blocks, and lighting-related computation blocks, the first category is different from the second category, the single file includes first and second versions of component data, the first version of the component data is associated with the first category of computation blocks, and the second version of the component data is associated with the second category of computation blocks.

A fourth example apparatus in accordance with some embodiments may include: a processor; and a non-transitory computer-readable medium storing instructions operative, when executed by the processor, to cause the apparatus to perform any of the methods listed above.

A fifth example method in accordance with some embodiments may include: obtaining information indicating interaction with one or more handlers used in processing a three-dimensional (3D) scene; identifying handler data, object data, and component data associated with at least one respective handler of the one or more handlers used; obtaining, at a scene-level, handler data from a dedicated structure for the respective handler; obtaining, at a node-level, for at least one node associated with the respective handler, object data from the dedicated structure for the respective handler; obtaining, at a component-level, for at least one component associated with the respective node, component data from the dedicated structure for the respective handler; and determining handler support for the respective handler.

For some embodiments of the fifth example method, the one or more handlers include one or more renderers.

For some embodiments of the fifth example method, the one or more handlers include one or more computation blocks.

For some embodiments of the fifth example method, the one or more handlers include one or more renderers and one or more computation blocks.

A sixth example method in accordance with some embodiments may include: obtaining information indicating interaction with a handler used in processing a three-dimensional (3D) scene; obtaining handler data, object data, and component data from a dedicated structure for the handler; determining handler support for the handler; and responsive to determining handler support indicates local support, processing, via the handler, at least one of the handler data, the object data, and the component data.

A seventh example method in accordance with some embodiments may include: obtaining information indicating interaction with a handler used in processing a three-dimensional (3D) scene; obtaining handler data, object data, and component data from a dedicated structure for the handler; determining handler support for the handler; and responsive to determining handler support indicates delegation, sending, to a delegation device, at least one of the handler data, the object data, and the component data.

An eighth example method in accordance with some embodiments may include: obtaining information indicating interaction with one or more handlers used in processing a three-dimensional (3D) scene; identifying handler data, object data, and component data associated with at least one respective handler of the one or more handlers used; responsive to determining handler data is global scene data, adding, at a scene-level, handler data to a dedicated structure for the respective handler; adding, at a node-level, for at least one node associated with the respective renderer, object data to the dedicated structure for the respective handler; and adding, at a component-level, for at least one component associated with the respective node, component data to the dedicated structure for the respective handler.

For some embodiments of the eighth example method, one or more handlers include one or more renderers.

For some embodiments of the eighth example method, one or more handlers include one or more computation blocks.

For some embodiments of the eighth example method, one or more handlers include one or more renderers and one or more computation blocks.

A ninth example method in accordance with some embodiments may include: obtaining information corresponding to a scene description associated with a single node graph; and adding, to a dedicated structure, renderer data, object data, and component data associated with each of at least two respective renderers, wherein the dedicated structure comprises two or more representations of an object in a scene associated with the scene description.

For some embodiments of the ninth example method, the dedicated structure is compatible with a gITF format.

For some embodiments of the ninth example method, the dedicated structure is compatible with an MPEG-I Scene Description format.

For some embodiments of the ninth example method, the dedicated structure is stored in a single file.

For some embodiments of the ninth example method, at least one of the two or more representations of the object comprises mesh geometries of the object.

For some embodiments of the ninth example method, the dedicated structure comprises a data memory structure.

A ninth example apparatus in accordance with some embodiments may include: a processor; and a non-transitory computer-readable medium storing instructions operative, when executed by the processor, to cause the apparatus to perform any one of the methods listed above.

### BRIEF DESCRIPTION OF THE DRAWINGS

FIG. 1A is a schematic side view illustrating an example waveguide display that may be used with extended reality (XR) applications according to some embodiments.

FIG. 1B is a schematic side view illustrating an example alternative display type that may be used with extended reality applications according to some embodiments.

FIG. 1C is a schematic side view illustrating an example alternative display type that may be used with extended reality applications according to some embodiments.

FIG. 1D is a system diagram illustrating an example set of interfaces for a system according to some embodiments.

FIG. 2 is a system diagram illustrating an example set of interfaces for an MPEG-I node hierarchy supporting elements of scene interactivity according to some embodiments.

FIG. 3 is a system diagram illustrating an example set of interfaces for gITF node hierarchy according to some embodiments.

FIG. 4 is an illustration showing an example of several representations of a virtual car targeting several renderers/computation modules/blocks according to some embodiments.

FIG. 5 is an illustration showing an example XR use case with several renderers and computation modules/blocks according to some embodiments.

FIG. 6 is an illustration showing an example of several representations of a virtual tree targeting several renderers/computation modules/blocks according to some embodiments.

FIG. 7 is a flowchart illustrating an example process for generating a single shared scene graph storing all the XR data according to some embodiments.

FIGS. 8A-8B are flowcharts illustrating an example process for retrieving, at the client side, XR data from a shared scene graph according to some embodiments.

FIGS. 9A-9D are code listings for an example scene description file related to the XR use case of FIG. 3 according to some embodiments.

FIG. 10 is a code listing for example mappings of delegated renderers/computation modules according to some embodiments.

FIG. 11 is a flowchart illustrating an example process for generating a single shared scene graph according to some embodiments.

The entities, connections, arrangements, and the like that are depicted in—and described in connection with—the various figures are presented by way of example and not by way of limitation. As such, any and all statements or other indications as to what a particular figure “depicts,” what a particular element or entity in a particular figure “is” or “has,” and any and all similar statements—that may in isolation and out of context be read as absolute and therefore limiting—may only properly be read as being constructively preceded by a clause such as “In at least one embodiment, . . . .” For brevity and clarity of presentation, this implied leading clause is not repeated ad nauseum in the detailed description.

### DETAILED DESCRIPTION

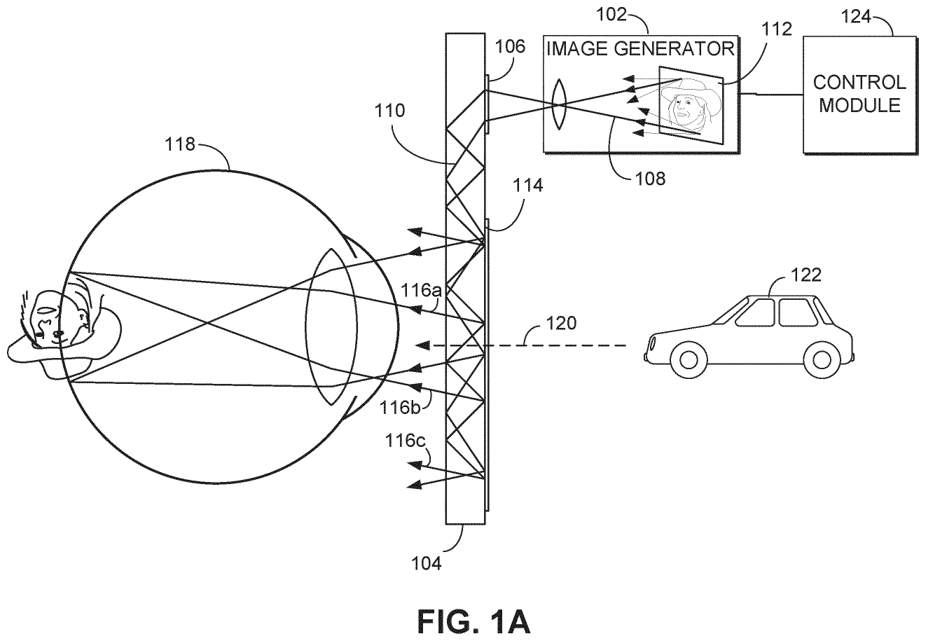

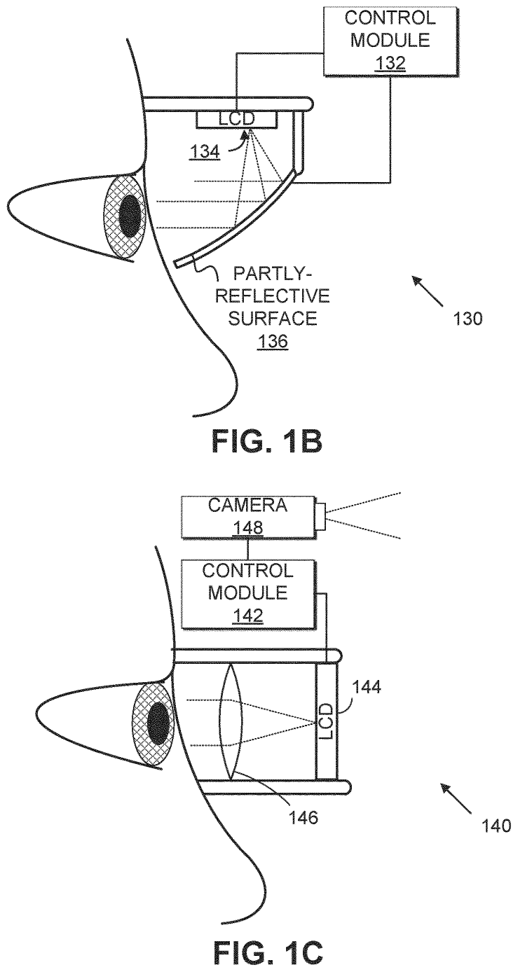

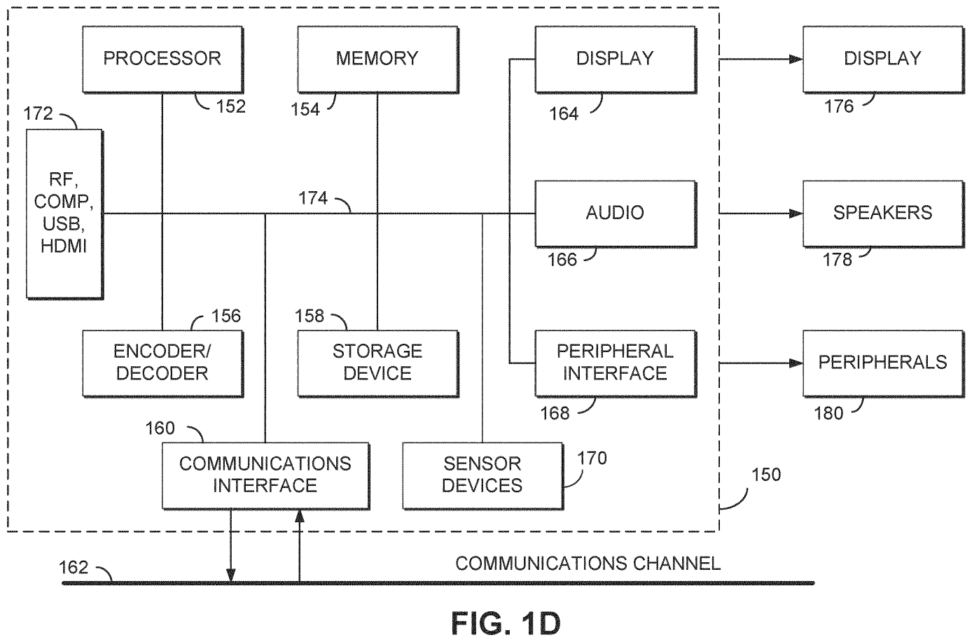

FIG. 1A is a schematic side view illustrating an example waveguide display that may be used with extended reality (XR) applications according to some embodiments. An image is projected by an image generator 102. The image generator 102 may use one or more of various techniques for projecting an image. For example, the image generator 102 may be a laser beam scanning (LBS) projector, a liquid crystal display (LCD), a light-emitting diode (LED) display (including an organic LED (OLED) or micro LED (μLED) display), a digital light processor (DLP), a liquid crystal on silicon (LCoS) display, or other type of image generator or light engine.

Light representing an image 112 generated by the image generator 102 is coupled into a waveguide 104 by a diffractive in-coupler 106. The in-coupler 106 diffracts the light representing the image 112 into one or more diffractive orders. For example, light ray 108, which is one of the light rays representing a portion of the bottom of the image, is diffracted by the in-coupler 106, and one of the diffracted orders 110 (e.g. the second order) is at an angle that is capable of being propagated through the waveguide 104 by total internal reflection. The image generator 102 displays images as directed by a control module 124, which operates to render image data, video data, point cloud data, or other displayable data.

At least a portion of the light 110 that has been coupled into the waveguide 104 by the diffractive in-coupler 106 is coupled out of the waveguide by a diffractive out-coupler 114. At least some of the light coupled out of the waveguide 104 replicates the incident angle of light coupled into the waveguide. For example, in the illustration, out-coupled light rays 116a, 116b, and 116c replicate the angle of the in-coupled light ray 108. Because light exiting the out-coupler replicates the directions of light that entered the in-coupler, the waveguide substantially replicates the original image 112. A user's eye 118 can focus on the replicated image.

In the example of FIG. 1A, the out-coupler 114 out-couples only a portion of the light with each reflection allowing a single input beam (such as beam 108) to generate multiple parallel output beams (such as beams 116a, 116b, and 116c). In this way, at least some of the light originating from each portion of the image is likely to reach the user's eye even if the eye is not perfectly aligned with the center of the out-coupler. For example, if the eye 118 were to move downward, beam 116c may enter the eye even if beams 116a and 116b do not, so the user can still perceive the bottom of the image 112 despite the shift in position. The out-coupler 114 thus operates in part as an exit pupil expander in the vertical direction. The waveguide may also include one or more additional exit pupil expanders (not shown in FIG. 1A) to expand the exit pupil in the horizontal direction.

In some embodiments, the waveguide 104 is at least partly transparent with respect to light originating outside the waveguide display. For example, at least some of the light 120 from real-world objects (such as object 122) traverses the waveguide 104, allowing the user to see the real-world objects while using the waveguide display. As light 120 from real-world objects also goes through the diffraction grating 114, there will be multiple diffraction orders and hence multiple images. To minimize the visibility of multiple images, it is desirable for the diffraction order zero (no deviation by 114) to have a great diffraction efficiency for light 120 and order zero, while higher diffraction orders are lower in energy. Thus, in addition to expanding and out-coupling the virtual image, the out-coupler 114 is preferably configured to let through the zero order of the real image. In such embodiments, images displayed by the waveguide display may appear to be superimposed on the real world.

FIG. 1B is a schematic side view illustrating an example alternative display type that may be used with extended reality applications according to some embodiments. In an XR head-mounted display device 130, a control module 132 controls a display 134, which may be an LCD, to display an image. The head-mounted display includes a partly-reflective surface 136 that reflects (and in some embodiments, both reflects and focuses) the image displayed on the LCD to make the image visible to the user. The partly-reflective surface 136 also allows the passage of at least some exterior light, permitting the user to see their surroundings.

FIG. 1C is a schematic side view illustrating an example alternative display type that may be used with extended reality applications according to some embodiments. In an XR head-mounted display device 140, a control module 142 controls a display 144, which may be an LCD, to display an image. The image is focused by one or more lenses of display optics 146 to make the image visible to the user. In the example of FIG. 1C, exterior light does not reach the user's eyes directly. However, in some such embodiments, an exterior camera 148 may be used to capture images of the exterior environment and display such images on the display 144 together with any virtual content that may also be displayed.

The embodiments described herein are not limited to any particular type or structure of XR display device.

FIG. 1D is a system diagram illustrating an example set of interfaces for a system according to some embodiments. An extended reality display device, together with its control electronics, may be implemented using a system such as the system of FIG. 1D. System 150 can be embodied as a device including the various components described below and is configured to perform one or more of the aspects described in this document. Examples of such devices, include, but are not limited to, various electronic devices such as personal computers, laptop computers, smartphones, tablet computers, digital multimedia set top boxes, digital television receivers, personal video recording systems, connected home appliances, and servers. Elements of system 150, singly or in combination, can be embodied in a single integrated circuit (IC), multiple ICs, and/or discrete components. For example, in at least one embodiment, the processing and encoder/decoder elements of system 150 are distributed across multiple ICs and/or discrete components. In various embodiments, the system 150 is communicatively coupled to one or more other systems, or other electronic devices, via, for example, a communications bus or through dedicated input and/or output ports. In various embodiments, the system 1000 is configured to implement one or more of the aspects described in this document.

The system 150 includes at least one processor 152 configured to execute instructions loaded therein for implementing, for example, the various aspects described in this document. Processor 152 may include embedded memory, input output interface, and various other circuitries as known in the art. The system 150 includes at least one memory 154 (e.g., a volatile memory device, and/or a non-volatile memory device). System 150 may include a storage device 158, which can include non-volatile memory and/or volatile memory, including, but not limited to, Electrically Erasable Programmable Read-Only Memory (EEPROM), Read-Only Memory (ROM), Programmable Read-Only Memory (PROM), Random Access Memory (RAM), Dynamic Random Access Memory (DRAM), Static Random Access Memory (SRAM), flash, magnetic disk drive, and/or optical disk drive. The storage device 158 can include an internal storage device, an attached storage device (including detachable and non-detachable storage devices), and/or a network accessible storage device, as non-limiting examples.

System 150 includes an encoder/decoder module 156 configured, for example, to process data to provide an encoded video or decoded video, and the encoder/decoder module 156 can include its own processor and memory. The encoder/decoder module 156 represents module(s) that can be included in a device to perform the encoding and/or decoding functions. As is known, a device can include one or both of the encoding and decoding modules. Additionally, encoder/decoder module 156 can be implemented as a separate element of system 150 or can be incorporated within processor 152 as a combination of hardware and software as known to those skilled in the art.

Program code to be loaded onto processor 152 or encoder/decoder 156 to perform the various aspects described in this document can be stored in storage device 158 and subsequently loaded onto memory 154 for execution by processor 152. In accordance with various embodiments, one or more of processor 152, memory 154, storage device 158, and encoder/decoder module 156 can store one or more of various items during the performance of the processes described in this document. Such stored items can include, but are not limited to, the input video, the decoded video or portions of the decoded video, the bitstream, matrices, variables, and intermediate or final results from the processing of equations, formulas, operations, and operational logic.

In some embodiments, memory inside of the processor 152 and/or the encoder/decoder module 156 is used to store instructions and to provide working memory for processing that is needed during encoding or decoding. In other embodiments, however, a memory external to the processing device (for example, the processing device can be either the processor 152 or the encoder/decoder module 152) is used for one or more of these functions. The external memory can be the memory 154 and/or the storage device 158, for example, a dynamic volatile memory and/or a non-volatile flash memory. In several embodiments, an external non-volatile flash memory is used to store the operating system of, for example, a television. In at least one embodiment, a fast external dynamic volatile memory such as a RAM is used as working memory for video coding and decoding operations, such as for MPEG-2 (MPEG refers to the Moving Picture Experts Group, MPEG-2 is also referred to as ISO/IEC 13818, and 13818-1 is also known as H.222, and 13818-2 is also known as H.262), HEVC (HEVC refers to High Efficiency Video Coding, also known as H.265 and MPEG-H Part 2), or VVC (Versatile Video Coding, a new standard being developed by JVET, the Joint Video Experts Team).

The input to the elements of system 150 can be provided through various input devices as indicated in block 172. Such input devices include, but are not limited to, (i) a radio frequency (RF) portion that receives an RF signal transmitted, for example, over the air by a broadcaster, (ii) a Component (COMP) input terminal (or a set of COMP input terminals), (iii) a Universal Serial Bus (USB) input terminal, and/or (iv) a High Definition Multimedia Interface (HDMI) input terminal. Other examples, not shown in FIG. 1C, include composite video.

In various embodiments, the input devices of block 172 have associated respective input processing elements as known in the art. For example, the RF portion can be associated with elements suitable for (i) selecting a desired frequency (also referred to as selecting a signal, or band-limiting a signal to a band of frequencies), (ii) downconverting the selected signal, (iii) band-limiting again to a narrower band of frequencies to select (for example) a signal frequency band which can be referred to as a channel in certain embodiments, (iv) demodulating the downconverted and band-limited signal, (v) performing error correction, and (vi) demultiplexing to select the desired stream of data packets. The RF portion of various embodiments includes one or more elements to perform these functions, for example, frequency selectors, signal selectors, band-limiters, channel selectors, filters, downconverters, demodulators, error correctors, and demultiplexers. The RF portion can include a tuner that performs various of these functions, including, for example, downconverting the received signal to a lower frequency (for example, an intermediate frequency or a near-baseband frequency) or to baseband. In one set-top box embodiment, the RF portion and its associated input processing element receives an RF signal transmitted over a wired (for example, cable) medium, and performs frequency selection by filtering, downconverting, and filtering again to a desired frequency band. Various embodiments rearrange the order of the above-described (and other) elements, remove some of these elements, and/or add other elements performing similar or different functions. Adding elements can include inserting elements in between existing elements, such as, for example, inserting amplifiers and an analog-to-digital converter. In various embodiments, the RF portion includes an antenna.

Additionally, the USB and/or HDMI terminals can include respective interface processors for connecting system 150 to other electronic devices across USB and/or HDMI connections. It is to be understood that various aspects of input processing, for example, Reed-Solomon error correction, can be implemented, for example, within a separate input processing IC or within processor 152 as necessary. Similarly, aspects of USB or HDMI interface processing can be implemented within separate interface ICs or within processor 152 as necessary. The demodulated, error corrected, and demultiplexed stream is provided to various processing elements, including, for example, processor 152, and encoder/decoder 156 operating in combination with the memory and storage elements to process the datastream as necessary for presentation on an output device.

Various elements of system 150 can be provided within an integrated housing, Within the integrated housing, the various elements can be interconnected and transmit data therebetween using suitable connection arrangement 174, for example, an internal bus as known in the art, including the Inter-IC (I2C) bus, wiring, and printed circuit boards.

The system 150 includes communication interface 160 that enables communication with other devices via communication channel 162. The communication interface 160 can include, but is not limited to, a transceiver configured to transmit and to receive data over communication channel 162. The communication interface 160 can include, but is not limited to, a modem or network card and the communication channel 162 can be implemented, for example, within a wired and/or a wireless medium.

Data is streamed, or otherwise provided, to the system 150, in various embodiments, using a wireless network such as a Wi-Fi network, for example IEEE 802.11 (IEEE refers to the Institute of Electrical and Electronics Engineers). The Wi-Fi signal of these embodiments is received over the communications channel 162 and the communications interface 160 which are adapted for Wi-Fi communications. The communications channel 162 of these embodiments is typically connected to an access point or router that provides access to external networks including the Internet for allowing streaming applications and other over-the-top communications. Other embodiments provide streamed data to the system 150 using a set-top box that delivers the data over the HDMI connection of the input block 172. Still other embodiments provide streamed data to the system 150 using the RF connection of the input block 172. As indicated above, various embodiments provide data in a non-streaming manner. Additionally, various embodiments use wireless networks other than Wi-Fi, for example a cellular network or a Bluetooth network.

The system 150 can provide an output signal to various output devices, including a display 176, speakers 178, and other peripheral devices 180. The display 176 of various embodiments includes one or more of, for example, a touchscreen display, an organic light-emitting diode (OLED) display, a curved display, and/or a foldable display. The display 176 can be for a television, a tablet, a laptop, a cell phone (mobile phone), or other device. The display 176 can also be integrated with other components (for example, as in a smart phone), or separate (for example, an external monitor for a laptop). The other peripheral devices 180 include, in various examples of embodiments, one or more of a stand-alone digital video disc (or digital versatile disc) (DVR, for both terms), a disk player, a stereo system, and/or a lighting system. Various embodiments use one or more peripheral devices 180 that provide a function based on the output of the system 150. For example, a disk player performs the function of playing the output of the system 150.

In various embodiments, control signals are communicated between the system 150 and the display 176, speakers 178, or other peripheral devices 180 using signaling such as AV. Link, Consumer Electronics Control (CEC), or other communications protocols that enable device-to-device control with or without user intervention. The output devices can be communicatively coupled to system 1000 via dedicated connections through respective interfaces 164, 166, and 168. Alternatively, the output devices can be connected to system 150 using the communications channel 162 via the communications interface 160. The display 176 and speakers 178 can be integrated in a single unit with the other components of system 150 in an electronic device such as, for example, a television. In various embodiments, the display interface 164 includes a display driver, such as, for example, a timing controller (T Con) chip.

The display 176 and speaker 178 can alternatively be separate from one or more of the other components, for example, if the RF portion of input 172 is part of a separate set-top box. In various embodiments in which the display 176 and speakers 178 are external components, the output signal can be provided via dedicated output connections, including, for example, HDMI ports, USB ports, or COMP outputs.

The system 150 may include one or more sensor devices 168. Examples of sensor devices that may be used include one or more GPS sensors, gyroscopic sensors, accelerometers, light sensors, cameras, depth cameras, microphones, and/or magnetometers. Such sensors may be used to determine information such as user's position and orientation. Where the system 150 is used as the control module for an extended reality display (such as control modules 124, 132), the user's position and orientation may be used in determining how to render image data such that the user perceives the correct portion of a virtual object or virtual scene from the correct point of view. In the case of head-mounted display devices, the position and orientation of the device itself may be used to determine the position and orientation of the user for the purpose of rendering virtual content. In the case of other display devices, such as a phone, a tablet, a computer monitor, or a television, other inputs may be used to determine the position and orientation of the user for the purpose of rendering content. For example, a user may select and/or adjust a desired viewpoint and/or viewing direction with the use of a touch screen, keypad or keyboard, trackball, joystick, or other input. Where the display device has sensors such as accelerometers and/or gyroscopes, the viewpoint and orientation used for the purpose of rendering content may be selected and/or adjusted based on motion of the display device.

The embodiments can be carried out by computer software implemented by the processor 152 or by hardware, or by a combination of hardware and software. As a non-limiting example, the embodiments can be implemented by one or more integrated circuits. The memory 154 can be of any type appropriate to the technical environment and can be implemented using any appropriate data storage technology, such as optical memory devices, magnetic memory devices, semiconductor-based memory devices, fixed memory, and removable memory, as non-limiting examples. The processor 152 can be of any type appropriate to the technical environment, and can encompass one or more of microprocessors, general purpose computers, special purpose computers, and processors based on a multi-core architecture, as non-limiting examples.

### Scene Description Framework for XR

The present principles generally relate to the domain of rendering of extended reality scene description and extended reality rendering. The present document is also understood in the context of the formatting and the playing of extended reality applications when rendered on end-user devices such as mobile devices or Head-Mounted Displays (HMD).

Extended reality (XR) is a technology enabling interactive experiences where the real-world environment and/or a video content is enhanced by virtual content, which can be defined across multiple sensory modalities, including visual, auditory, haptic, etc. During runtime of the application, the virtual content (3D content or audio/video file for example) is rendered in real-time in a way which is consistent with the user context (environment, point of view, device, etc.). Scene graphs (such as the one proposed by Kronos/gITF and its extensions defined in MPEG Scene Description format or Apple/USDZ for instance) are a possible way to represent the content to be rendered. They combine a declarative description of the scene structure linking real-environment objects and virtual objects on one hand, and binary representations of the virtual content on the other hand.

Although such MPEG scene description frameworks ensure that the timed media and the corresponding relevant virtual content are available at any time during the rendering of the application, there is no description of how a user can interact with the scene objects at runtime for immersive XR experiences.

There is a lack of an XR system that can take an XR scene description including metadata describing how a user can interact with the scene objects at runtime and how these interactions may be updated during runtime of the XR application.

In XR applications, a scene description is used to combine explicit and easy-to-parse description of a scene structure and some binary representations of media content.

In time-based media streaming, the scene description itself may be time-evolving to provide the relevant virtual content for each sequence of a media stream. For instance, for advertising purpose, a virtual bottle may be displayed during a video sequence where people are drinking.

For some embodiments, the framework described in the document, Scene Description for MPEG Media Document, Information Technology—Coded Representation of Immersive Media—Part14: Scene Description for MPEG Media, International Organization for Standardization (ISO), ISO/IEC DIS 23090-14 :2021 (E) (2021), may be used.

### Runtime Interactivity

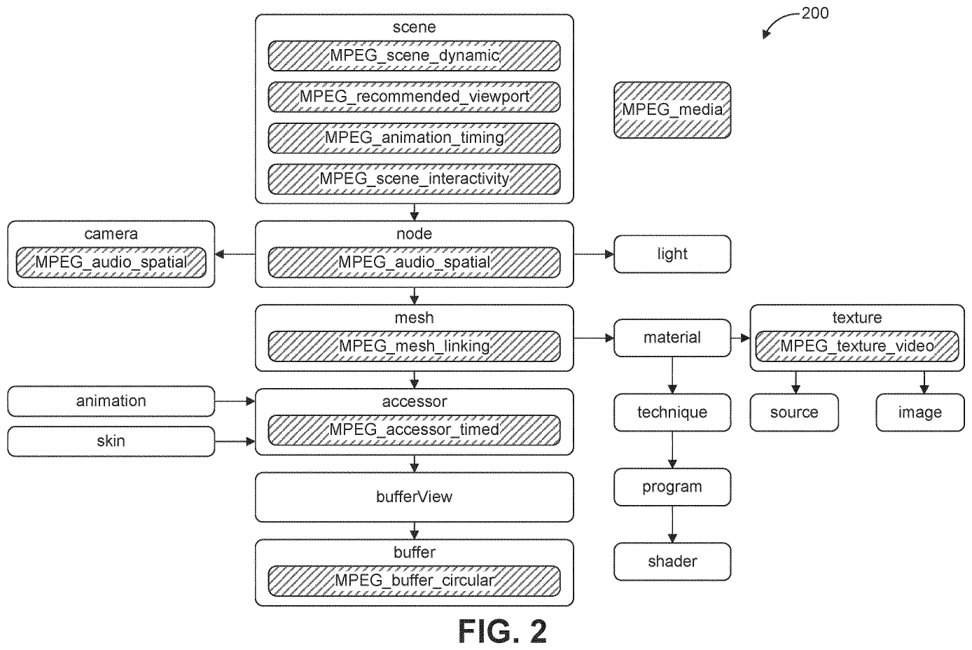

FIG. 2 is a system diagram illustrating an example set of interfaces for an MPEG-I node hierarchy supporting elements of scene interactivity according to some embodiments. According to the present principles, some of which are shown in the node hierarchy 200, in addition to a node tree, behavior metadata items (examples of what are herein called ‘behaviors’) are added to the scene description. In example embodiments, the time-evolving scene description is augmented by adding information identifying behaviors. These behaviors may be related to pre-defined virtual objects on which runtime interactivity is allowed for user specific XR experiences.

In some embodiments, these behaviors are time-evolving. In such embodiments, the behaviors may be updated through the already-existing scene description update mechanism.

In example embodiments, a behavior may be characterized by one or more of the following properties:
One or more triggers defining the conditions to be met for activation.
A trigger control parameter defining the logical operations between the defined triggers.
Actions to be implemented in response to the activation of the triggers.
An action control parameter defining the order of execution of the defined actions.
A priority number enabling the selection of the behavior of highest priority in the case of concurrence of several behaviors on the same virtual object at the same time.
An interrupt action to specify how to terminate this behavior when the behavior is no longer defined in a newly received scene update. For instance, a behavior is no longer defined if the related object has been removed or if the behavior is no longer relevant for this current media (e.g. audio or video) sequence.

With the addition of these behaviors, time-dependent user interactivity in immersive content for XR experiences may be defined.

When a second scene description is received, some of the behaviors of the first scene description may be “on-going”, e.g., they are triggered, and their actions are running. The second scene description may be provided as update metadata, e.g., metadata describing the differences between the first scene description and the second description. The second scene description includes a node tree describing objects that may be common or different than objects of the first scene descriptions. Objects of the node tree of the first scene description may be no longer present in the second description. If the objects related to the running actions of the on-going behaviors are missing in the second scene description, then, these on-going behaviors are no longer appliable. If an on-going behavior is not defined in the second description, the on-going behavior is no longer appliable. The interrupt action field describes how to interrupt the running actions on the on-going behavior.

In XR applications, a scene description is used to combine explicit and easy-to-parse description of a scene structure and some binary representations of media content.

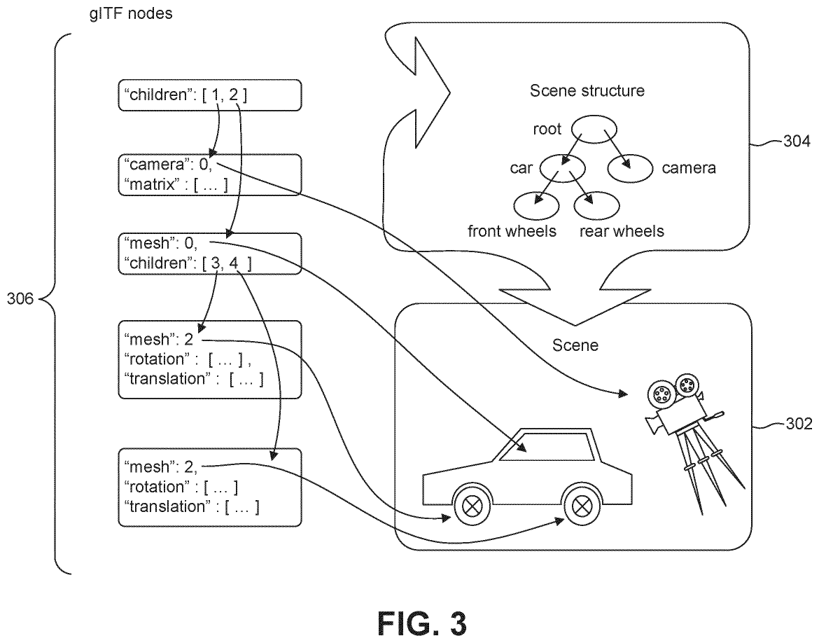

FIG. 3 is a system diagram illustrating an example set of interfaces for gITF node hierarchy according to some embodiments. As shown in the example of FIG. 3, a scene 302 has a scene structure 304 that contains a node graph with a single root node. The root node has two children nodes for a camera and a car. The car node has two children nodes for the front wheels and the rear wheels. The scene shown in FIG. 3 shows a car being filmed by a camera. The left side of FIG. 3 shows an example of a gITF nodes array structure 306. For the root node, nodes are indicated as element #1 of the “children” array for the first node (camera) and element #2 of the “children” array for the second node (car). The camera node structure includes a “matrix” array that provides the spatial transformation (which may include translation, rotation, and scale and which is shown as “ . . . ” in FIG. 3) of that node with respect to its parent node. The car node structure includes references to element #3 (front wheels node) and element #4 of the “children” array (rear wheels node). The structure for the front wheels node includes information regarding “rotation” and “translation” values (which are both shown as “ . . . ” in FIG. 3). The structure for the rear wheels node includes information regarding “rotation” and “translation” values (which are also both shown as “ . . . ” in FIG. 3).

Rich XR experiences may be supported by: (1) multiple renderers such as visual, immersive audio and haptics renderers; and (2) multiple computation modules such as physics engine, Augmented Reality (AR) anchor detection and tracking, interactivity, and lighting estimation. Such renderers and computation modules/blocks use data which may be provided in a spatially and timely structured manner. A node graph-based scene description stores and transmits such data from a server to user equipment.

Several scene description formats are available and are targeting mainly one or a subset of renderers: Khronos's gITF, which is delineated in GLTF 2.0 SPECIFICATION, Khronos 3D Formats Working Group (October 2021), available at registry<dot>khronos<dot>org/gITF/via github<dot>com/KhronosGroup/gITF (“Khronos gITP”), provides geometric, texture, camera, animation, lighting data to be used by a visual renderer, and MPEG-I immersive audio group has defined an Encoder Input Format (EIF) format, which is discussed in MPEG-I IMMERSIVE AUDIO ENCODER INPUT FORMAT, Version 3, International Organization for Standardization (ISO), ISO/IEC JTC 1/SC 29/WG 6 (Oct. 28, 2022), available at isotc<dot>iso<dot>org/livelink/livelink/open/jtc1sc29wg6, to transmit acoustic data to be used by an immersive audio renderer.

For rich XR experiences that use several renderers, several scene graphs may be generated to store and transmit the data. For instance, one scene graph may be generated for each renderer. However, a limitation of this approach is maintaining the spatial and temporal consistencies of scene graphs targeting several renderers. Hence, an example problem statement may indicate a problem with maintaining spatial and temporal consistencies of scene graphs targeting several renderers.

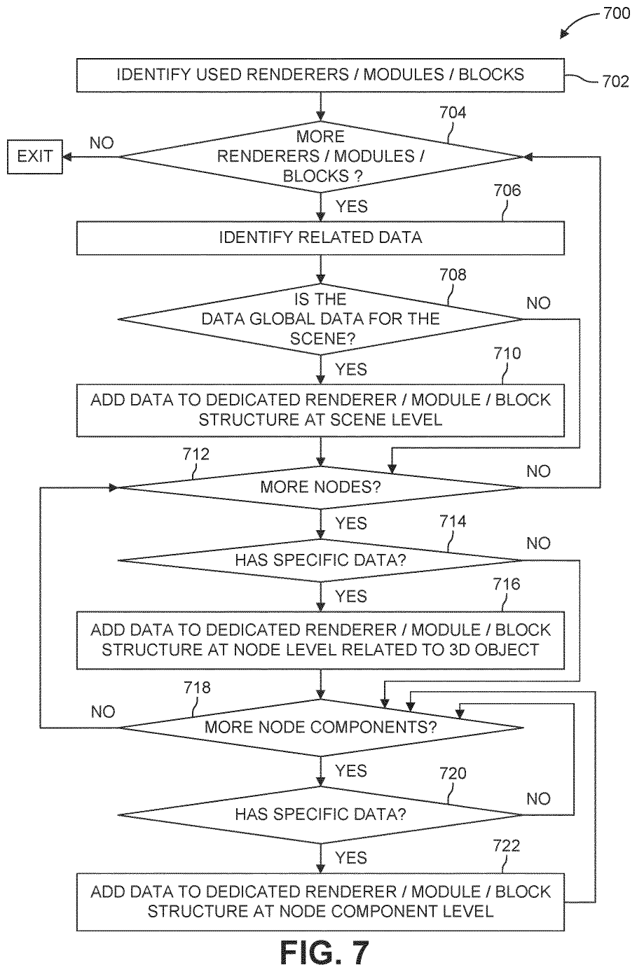

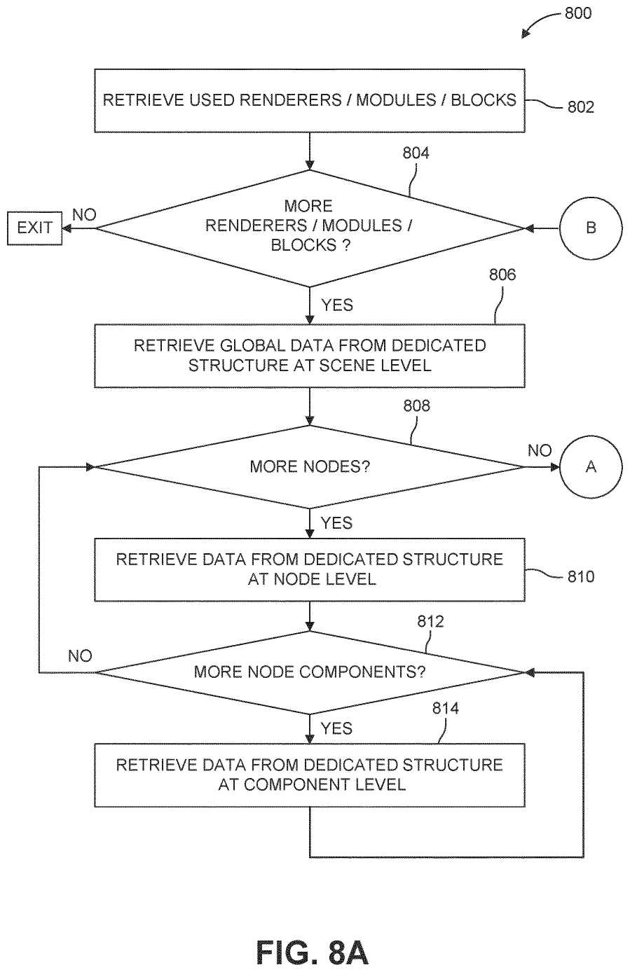

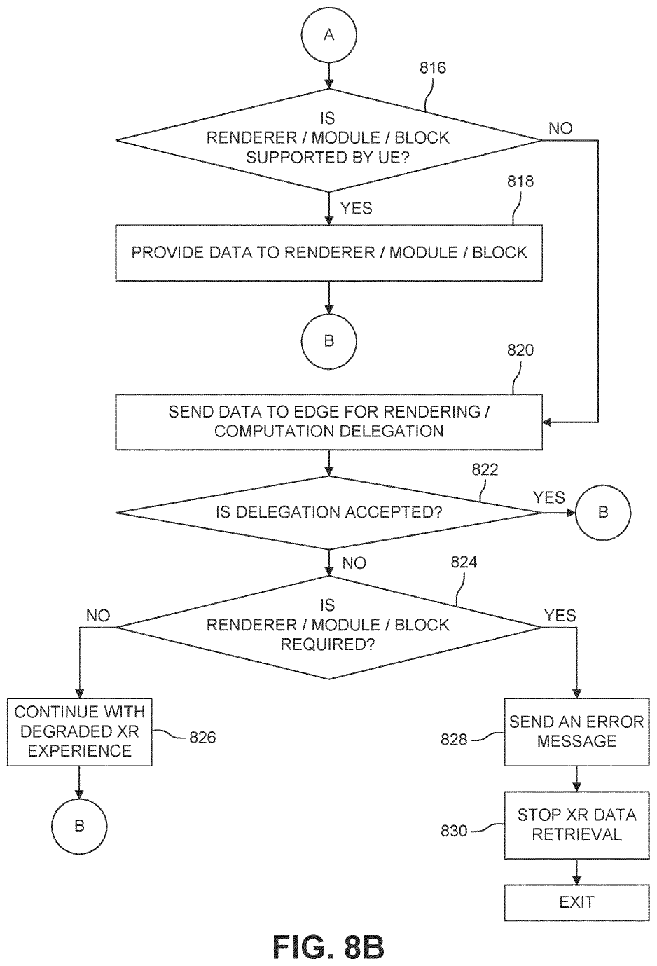

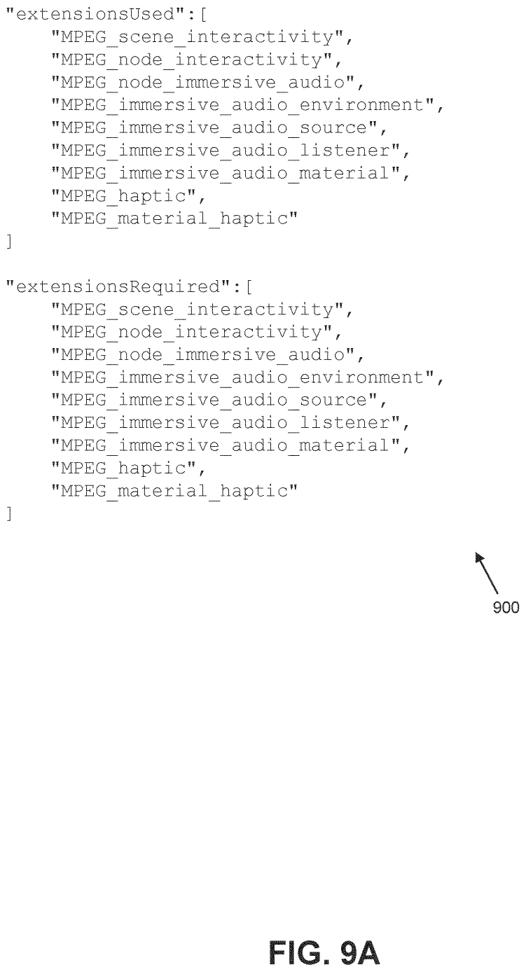

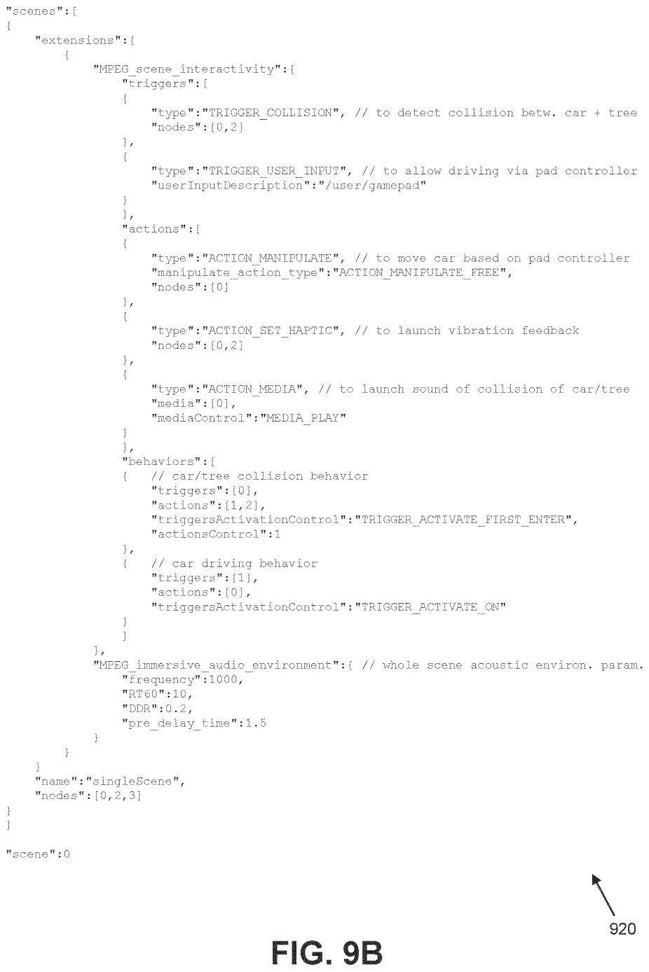

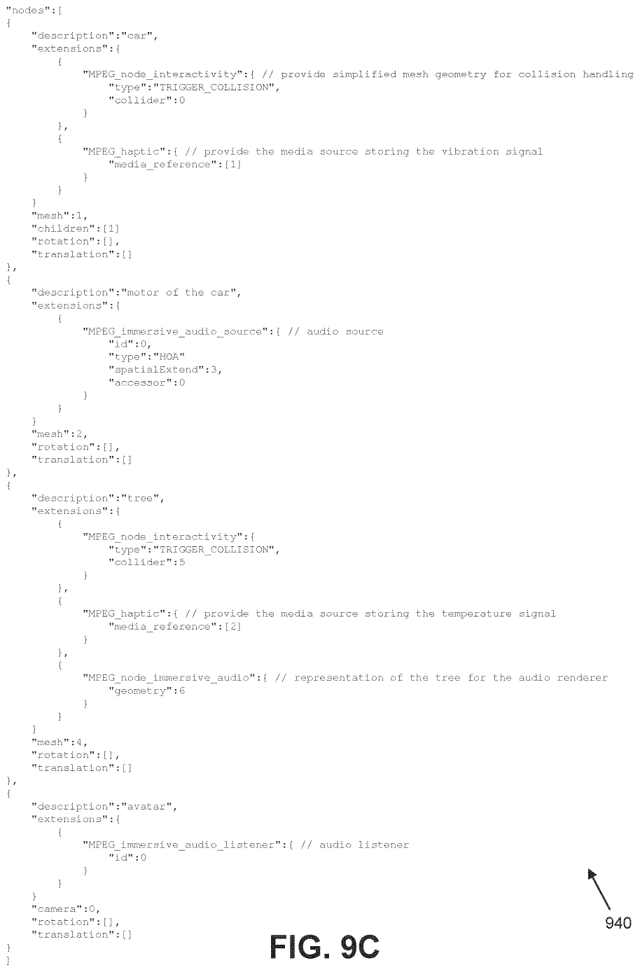

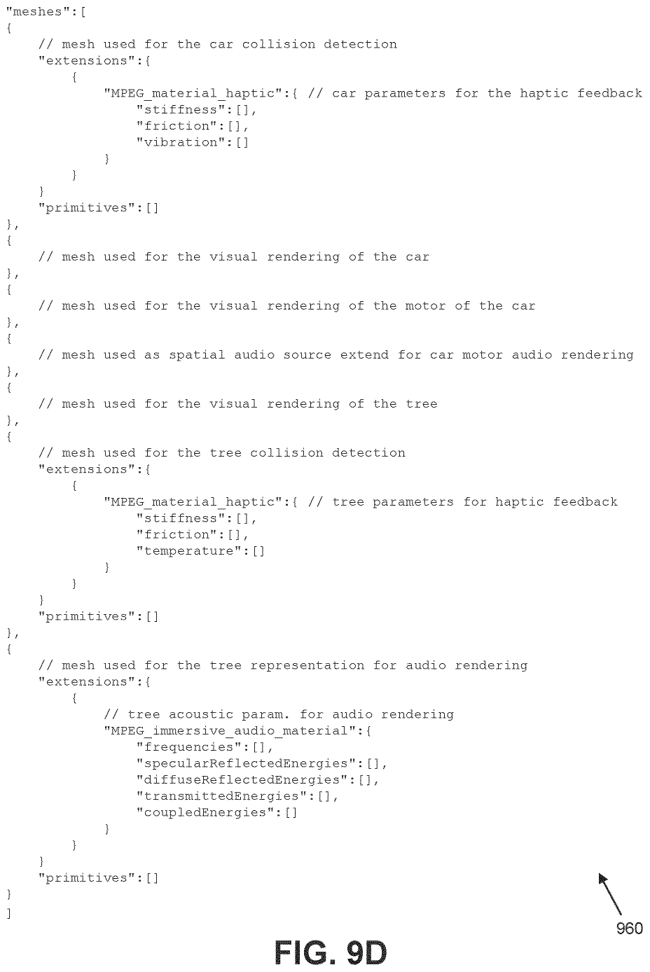

The MPEG-I Scene Description is based on the Khronos gITF format. The new semantic, as explained in this application, is done through the Khronos vendor extension mechanism, as shown in FIGS. 9A-9D. As a result, a single scene graph may support, for example, dedicated structures for providing EIF scene description data within the MPEG-I Scene Description (SD). FIG. 7 shows an example of how such a file may be generated, and FIGS. 8A-8B show an example of how such a file may be unpacked and used by an XR client.

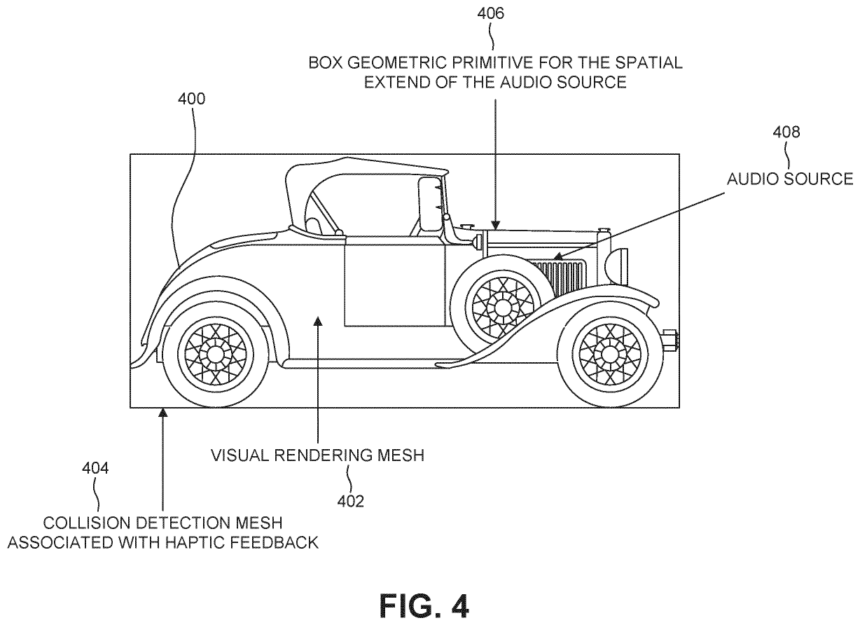

FIG. 4 is an illustration showing an example of several representations of a virtual car targeting several renderers/computation modules/blocks according to some embodiments. For instance, as shown in FIG. 4, a moving virtual car 400 may be represented by highly detailed meshes and textures for the visual rendering 402. Mesh primitives, such as an Axis-Aligned Bounding Box (AABB), may be associated with acoustic material for audio rendering. For example, a geometric box primitive 406 may be used for spatial aspects of an audio source 408, which is the motor of the car in this example. An AABB and/or mesh 404 may be used for collision detection and interactivity computations associated with haptic rendering(s) and feedback. For example, a box may be drawn around the extremities of the car as shown in FIG. 4. When the car is moving, the spatial and time consistencies of this rendering and/or computational data should be maintained.

For some embodiments, a single scene graph may be generated to store the data for handlers, such as the renderers (of which, some or all may be required for some embodiments) and computation blocks (e.g., computation modules). This approach is in the spirit of SUPPORT OF 5G GLASS-TYPE AUGMENTED REALITY/MIXED REALITY (AR/MR) DEVICES, 3rd Generation Partnership Project (3GPP), TR26.998, Release 17.0.0 (March 2022) (“3GPP TR26.998”) (See section 4.3, Basic Processes for Delivering an AR Experience), in which an initial scene description document summarizing all the XR assets is provided as an entry point to the User Equipment (UE). Depending on the user equipment capabilities (which, for some embodiments, may be the ability of the UE to render and/or compute XR features), some parts may be delegated to the network edge. For instance, in a split rendering architecture (3GPP TR26.998 , section 6.3.4.2, EDGAR-Based Interactive Immersive Service), the UE delegates the visual rendering to the edge; only the decoding and display of the rendered 2D video stream is performed by the UE.

To support XR data in addition to visual data, gITF extensions to the MPEG-I SD standard may be created. Such extensions may include: acoustic data for audio support; interactivity data for physics engine support and efficient collision handling; lighting data; haptics data; and Augmented Reality anchor data for detection and tracking of features of the real environment, to name a few example extensions.

A single gITF file is able to store and transmit several scene graphs through the scenes array property. For some embodiments, for MPEG-I Scene Description (SD), each renderer/module-specific data may be gathered into a dedicated gITF scene. The visual data may be stored in the main gITF scene for visual rendering. However, as mentioned above, this approach in some use cases may require the spatial and temporal consistency constraints between these scene graphs.

To ensure spatial and temporal consistencies of all the data, a scene description composed of a single shared node graph may be provided. However, there is a lack of a framework to generate (at the server side) and to retrieve (at the client side) a single shared node graph containing all the data of all the renderers and computation modules/blocks for such an XR experience.

The application discusses, in accordance with some embodiments, a framework which generates (at the server side) and retrieves (at the client side) a scene description based on a single node graph containing all the data for the required renderers and computation modules for rich XR experiences. A node graph is related to a 3D object geometry and may contain several representations of that object. These representations target a dedicated renderer/computation module/block. Target renderers may be, e.g., audio, visual, or haptic renderers. Target computation blocks may, e.g., simulate the physics for realistic collision handling, lighting estimation, interactivity event processing, AR anchoring detection and tracking, and/or video processing. If the user equipment is, e.g., not capable of rendering or computing some data, the client may delegate these unsupported features to the network edge.

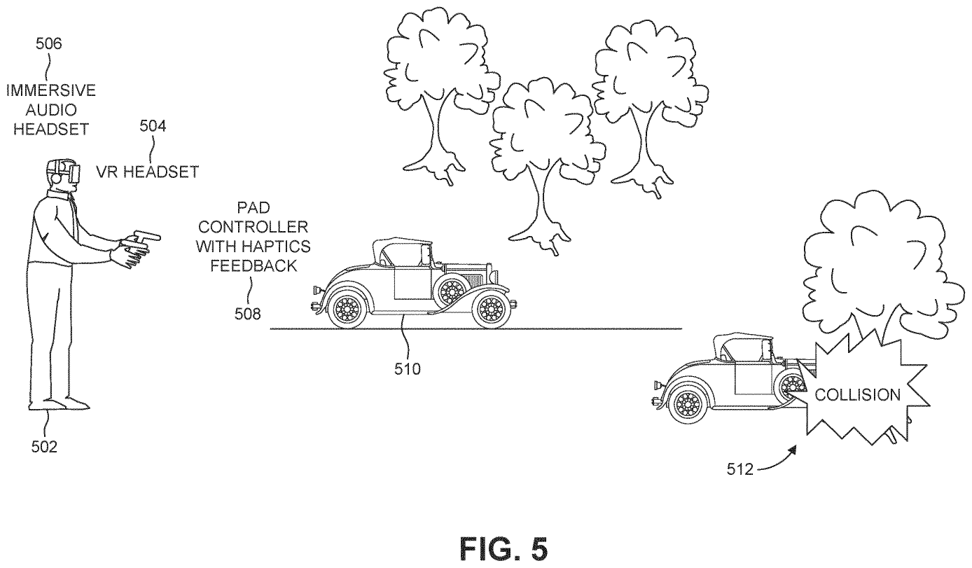

FIG. 5 is an illustration showing an example XR use case with several renderers and computation modules/blocks according to some embodiments. This application supports multiple use cases, such as the one shown in FIG. 5. FIGS. 4, 5, and 6 show examples of a full VR experience that may be provided for a virtual car moving inside a virtual environment. According to the examples, a user 502 may be equipped with an HMD/VR headset 504 to visualize the 3D virtual scene. The user also may wear an immersive audio headset 506 to hear the motor of the car 510. Additionally, the user may use a pad controller 508 to drive the car 510. If a collision 512 with a virtual tree occurs (as shown on the right side of FIG. 5), the user may hear the impact through the headphones and feel haptic feedback as a vibration on the pad controller.

To support such an example scenario, an XR server may generate visual, audio, physics and haptic data in a scene graph in a spatially and timely consistent manner. A scene description file may contain the scene graph transmitted across a network. A User Equipment (UE) device receives the scene description file and retrieves visual, audio, physics, and haptic data from the scene graph to feed the related renderers and computation modules/blocks. If the user equipment is, for example, not capable of rendering or computing some of the data, a delegation to the network edge may be requested for some embodiments.

### Generation of a Scene Graph at an XR Server

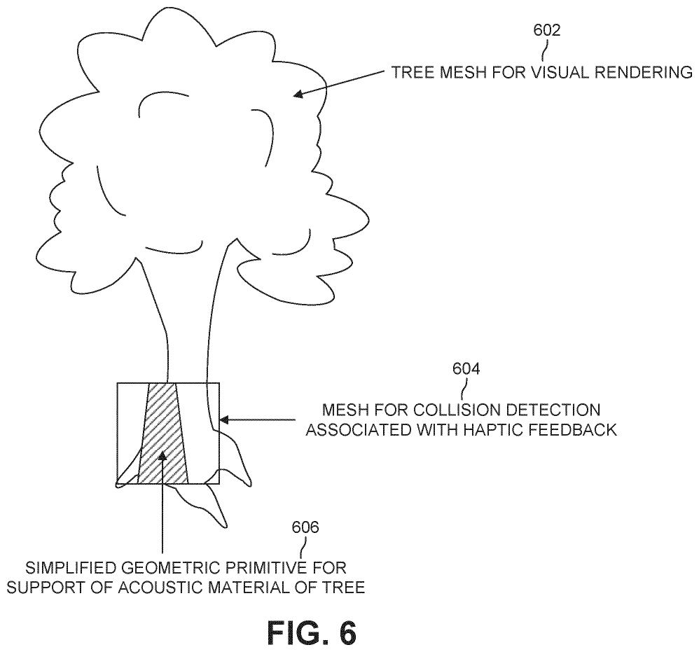

FIG. 6 is an illustration showing an example of several representations of a virtual tree targeting several renderers/computation modules/blocks according to some embodiments. As depicted in FIGS. 4 to 6, some objects in the 3D scene may use different representations depending on the target renderer or computation block (e.g., module). For example, the car of FIG. 4 may use a simplified geometry for audio source aspects but a richer geometry for visual rendering. Another geometry representation is provided for interactivity computations (such as collision detection). As another example, the tree of FIG. 6 may use a simplified geometric primitive 606 associated with and in support of an acoustic material for audio rendering. For visual rendering of the tree, a richer geometry, such as a detailed mesh 602, may be used. For collision detection, a simplified geometry primitive may be used. For example, a bounding box 604 (as shown in the example of FIG. 6) or a mesh may be used for collision detection associated with haptic feedback.

FIG. 7 is a flowchart illustrating an example process for generating a single shared scene graph storing all the XR data according to some embodiments. For some embodiments, the data may be inserted into the scene graph for each renderer/computation module/block by applying the following constraints. Data related to the whole scene are inserted by starting with the top scene level. The graph may be traversed from top to bottom by starting with a particular root node and progressing to leaf nodes associated with the particular node. Data related to a whole object is inserted at the corresponding node level. Data related to specific object attributes are inserted at the corresponding node component and sub-component level. For example, a mesh component may be inserted first at a component level, and a mesh material component may be inserted second at a sub-component level.

The flowchart 700 of FIG. 7 executes a series of loops that progressively go deeper into a scene graph structure. The renderers/computation modules/computation blocks used for a 3D XR scene may be identified 702. A determination 704 is made regarding the number of renderers/computation modules/computation blocks left. If no more renderers/computation modules/computation blocks exist to be processed, the flowchart exits. Otherwise, data related to the current renderer/computation module/computation block is identified 706. A determination 708 is made regarding whether the data is global data for the scene. If the identified data is global scene data, the identified data is added 710 to a dedicated renderer/computation module/computation block structure at the scene level. A determination 712 is made regarding whether more nodes exist. If no more nodes exist to be processed, the flowchart returns to assess if more renderers/computation modules/computation blocks exist to be processed. A determination 714 is made regarding whether the current node has specific data. If specific data is available for the current node, the specific data is added 716 to the dedicated renderer/computation module/computation block structure at the node level related to the associated 3D object. A determination 718 is made regarding whether there are more node components. If no more node components exist to be processed, the flowchart returns to assess if more nodes exist to be processed. A determination 720 is made regarding whether the current node component has specific data. If specific data is available for the current node component, the specific data is added 722 to the dedicated renderer/computation module/computation block structure at the node component level. The flowchart then returns to assess if more node components exist to be processed.

A graph node or component corresponding to an object may contain several types of data. Graph nodes and components provide a dedicated representation of an object for a renderer/computation module/block. For some embodiments, multiple versions of particular data may be stored. For example, a first renderer may use a first version of the particular data, and a second renderer may use a second version of the particular data. For example, the first version of the particular data may be a geometric mesh with a sparse level of detail, and the second version of the particular data may be a geometric mesh with an intricate and very detailed level of detail.

For some embodiments, one or more handlers may include one or more renderers. For some embodiments, one or more handlers may include one or more computation blocks. For some embodiments, one or more handlers may include one or more renderers and one or more computation blocks. For some embodiments, the term “renderer” may be replaced with the term “handler” and vice versa in this application. For some embodiments, the term “computation block” may be replaced by the term “handler” and vice versa in this application. For some embodiments, the term “computation module” may be replaced by the term “handler” and vice versa in this application.

### Data Retrieval of a Scene Graph at a Client

FIGS. 8A-8B are flowcharts illustrating an example process for retrieving, at the client side, XR data from a shared scene graph according to some embodiments. FIGS. 8A and 8B show an example process for retrieving data from a scene graph stored in a transmitted scene description file.

The flowchart 800 of FIGS. 8A and 8B executes a series of loops that progressively go deeper into a scene graph structure. The renderers/computation modules/computation blocks used for a 3D XR scene may be identified and retrieved 802. A determination 804 is made regarding whether there are more renderers/modules/blocks. If no more renderers/computation modules/computation blocks exist to be processed, the flowchart exits. Otherwise, global data is retrieved 806 from a dedicated renderer/computation module/computation block structure at the scene level. A determination 808 is made regarding whether more nodes exist. If no more nodes exist to be processed, then the flowchart progresses to the “A” connector at the top of FIG. 8B. Otherwise, 3D object data is retrieved 810 from the dedicated renderer/computation module/computation block structure at the node level. A determination 812 is made regarding whether there are more node components. If no more node components exist to be processed, the flowchart returns to assess if more nodes exist to be processed. Otherwise, component data is retrieved 814 from the dedicated renderer/computation module/computation block structure at the node component level, and then the flowchart returns to determine 812 if there are more node components. A determination 816 is made regarding whether the renderer/computation module/computation block is supported by the user environment (UE). If the renderer/computation module/computation block is supported by the UE, the associated component, object, and/or global data is provided 818 to the current renderer/computation module/computation block and then the flowchart returns to assess 804 if more renderers/modules/blocks exist to be processed. Otherwise, the associated component, object, and/or global data may be sent 820 to the network edge for rendering/computation delegation. A determination 822 is made regarding whether the delegation is accepted. If the delegation is accepted, the flowchart returns to assess 804 if more renderers/modules/blocks exist to be processed. Otherwise, a determination 824 is made regarding whether the renderer/module/block is required. If rendering/computation related to the associated component, object, and/or global data is not required, the UE may continue 826 with a degraded XR experience and return to assess 804 if more renderers/modules/blocks exist to be processed. Otherwise, an error message may be sent 828, and the UE may stop 830 retrieving XR data. For some embodiments, a delegation request summarizing unsupported renderers/computation blocks may be sent at the end of the XR data retrieval. For some embodiments, such a delegation request summarizes all renderers/computation blocks determined not to be supported.

The scene description file may provide dedicated metadata to facilitate the retrieval of the used and required renderers/computation modules for that XR experience. For instance, the gITF semantic provides dedicated “extensionsUsed” and “extensionsRequired” metadata (FIG. 9A). The “extensionsRequired” metadata may be relevant to stop the XR data retrieval in the case where no delegation for that related renderer/computation module has been found. The “extensionsUsed” metadata may be relevant to run the XR experience in a degraded operating mode without the related renderer/computation module/computation block. For example, running in a degraded operating mode may be due to, for example, (1) the user equipment not requesting a delegation, or (2) no applicable renderer/computation module/computation block being found.

For some embodiments, for each renderer/computation module/computation block, the data are retrieved from the scene graph by applying the following constraints. Data related to the whole scene are retrieved by starting with the top scene level. The graph may be traversed from top to bottom by starting with a particular root node and progressing to leaf nodes associated with the particular node. Data related to a whole object is retrieved at the corresponding node level. Data related to specific object attributes are retrieved at the corresponding node component and sub-component level. For example, a mesh component may be retrieved first at a component level, and a mesh material component may be retrieved second at a sub-component level.

Once the data is retrieved for a renderer/computation module/computation block, the User Equipment may determine if the rendering/computation is done locally or delegated to the network edge. For some embodiments, such an assessment is based on UE capabilities. Such an assessment may correspond to step 8 as shown in section 6.3.4.2 of 3GPP TR26.998 .

In the case of delegation, in accordance with some example embodiments, the User Equipment may provide, e.g., the following 3 pieces of information to an Edge Application Server (EAS): (1) the content of the receive scene description file, (2) which renderers/computation modules/computation blocks are not supported, and (3) User Equipment capabilities related to processing data coming from delegated renderers/computation modules/computation blocks.

For some embodiments, indicating which renderers/computation modules are not supported may include a User Equipment capable of computing some trigger activations but may not be capable of supporting physics simulation for an interactivity computation module/computation block. Additionally, for some embodiments, indicating which renderers/computation modules/computation blocks are not supported may include a User Equipment capable of supporting only a limited number of Augmented Reality anchor types (e.g., only those AR anchor types based on plane detection). For some embodiments, indicating which renderers/computation modules are not supported may be an indication of which renderers/computation modules/computation blocks require a complete or a partial delegation.

For some embodiments, indicating User Equipment capabilities related to processing data coming from delegated renderers/computation modules/computation blocks may include User Equipment with limited GPU capabilities thereby preventing 3D composition and rendering. In that case, the complete scene rendering may be delegated to the network edge. The User Equipment may provide 2D video decoding capabilities for reception of a rendered video stream

In some embodiments, the User Equipment may send, e.g., the 3 pieces of information listed above (the content of the receive scene description file, which renderers/computation modules are not supported, and User Equipment capabilities related to processing data coming from delegated renderers/computation modules/computation blocks) to an Edge Application Server (EAS) in a separate file (e.g., a JSON, XML, or text file) in addition to the initial gITF file.

In some embodiments, the User Equipment may generate a new scene description file, which may include: (1) the initial scene description file received by the User Equipment, (2) dedicated metadata indicating which renderers/computation modules/computation blocks are not supported, and (3) dedicated metadata indicating the supported feature(s) and format(s) in which the data resulting from the delegated rendering/computation modules/computation blocks which may be sent by the Edge Application Server (EAS).

For some embodiments, dedicated metadata indicating which renderers/computation modules/computation blocks are not supported may be indicated in a gITF-based scene description in which a new “extensionsUnsupported” section may be introduced at the gITF file level in addition to the already-existing “extensionsUsed” and “extensionsRequired” sections.

For some embodiments, dedicated metadata, which indicate supported feature(s) and format(s) in which the data resulting from the delegated rendering/computation modules may be sent by the Edge Application Server (EAS), may be processed by the User Equipment based on UE capabilities. For some embodiments, a supported feature may be associated with several supported formats, which may be defined and provided in an array (in a decreasing priority order, for instance)

### Scene Description File Transmitted Across a Network

FIGS. 9A-9D are code listings for an example scene description file related to the XR use case of FIG. 4 according to some embodiments. A scene description file is detailed in the scope of the MPEG-I Scene Description (SD) framework using the Khronos gITF extension mechanism to support additional scene description features.

As previously mentioned, the legacy gITF semantic (e.g., scene, node, mesh, . . . ) and associated data may be used by a visual renderer. For some embodiments, gITF extensions may be used to store other types of data attached to the node graph to address additional renderers and computation modules/blocks, which may include, for example, (1) interactivity extensions for the user/scene and scene/scene event computation; (2) haptic extensions to provide data to the haptic renderer when a collision occurs; and (3) immersive audio extensions to provide data to the audio renderer.

For some embodiments, interactivity extensions for the user/scene and scene/scene event computation may include such extensions that are described in application EP22305024, filed on Jan. 12, 2022; application EP22305197, filed on Feb. 23, 2022; application EP22305289, filed on Mar. 14, 2022; and application EP22305362, filed on Mar. 24, 2022, based on behavior objects composed of triggers and actions defined at the gITF scene level and dedicated trigger parameters at the gITF node level.

For the example code listings 900, 920, 940, 960 of FIGS. 9A-9D, the MPEG scene interactivity structure at the scene level indicates a collision behavior between the car and the tree may include: (1) a collision trigger in which dedicated meshes (FIG. 9D) have been referenced at the node level for the car and the tree; and (2) two actions to be launched in parallel. The two actions may include: (1) a SET_HAPTIC action to produce a vibration and temperature feedback; and (2) a MEDIA action to produce a sound. Additionally, a car driving behavior may include: (1) a user input trigger; and (2) a MANIPULATE action to move the car based on a pad controller.

For some embodiments, haptic extensions may provide data to the haptic renderer when a collision occurs. For the example of FIGS. 9A-9D, references (in FIG. 9C) to the haptic signals for vibration and temperature are provided at the node level for the car and tree objects. Additionally, for the example of FIGS. 9A-9D, dedicated haptic parameters to characterize vibration and temperature are provided in the haptic material extension (shown in FIG. 9D) attached to the collider meshes of the car and the tree.

For some embodiments, immersive audio extensions may provide data to the audio renderer. For the example of FIGS. 9A-9D, the MPEG immersive audio environment structure at the scene level (FIG. 9B) indicates parameters applicable to the whole scene, such as, e.g., an audio frequency, a 60 dB reverberation time (RT60), a Diffuse-to-Direct-Ratio (DDR), a pre-delay time, or other parameters.

Audio source data is attached (in FIG. 9C) to the node related to the motor of the car. Additionally, there is a reference to: the accessor for retrieving the audio signal (in FIG. 9C), the type of the audio source (here the Higher Order Ambisonics—HOA) (in FIG. 9C), and the spatial extend geometry perceived by the listener in an elevation-azimuth sector (also in FIG. 9C). The audio listener data is attached (in FIG. 9C) to the node having a camera and representing the user representation in the XR experience.

The acoustic data of an object is introduced at its related node level (tree node in FIG. 9C) by referencing a mesh geometry accessor (here 0, which indicates the first mesh). Then the data is provided (in FIG. 9D) at the mesh level within an acoustic material property. For each provided frequency, a specular reflected energy (back reflection in a distinct outgoing direction), a diffuse reflected energy (back scattering), a transmitted energy through the mesh geometry without changing the sound direction and a coupled energy (vibration in the structure which is re-emitted by the entire structure) are defined. For some embodiments, the acoustic data of the tree is provided at the mesh level. In some embodiments, the acoustic data of the tree may be provided at the mesh primitive level.

The MPEG-I Scene Description is based on the Khronos gITF format. The new semantic, as explained in this application, is done through the Khronos vendor extension mechanism, as shown in FIGS. 9A-9D. As a result, a single scene graph may support, for example, the audio/acoustic data defined in the EIF scene description format and the other types of data (which include visual, interactivity, and haptics data) defined in MPEG-I Scene Description (SD). FIG. 7 shows an example of how such a file may be generated, and FIGS. 8A-8B show an example of how such a file may be unpacked and used by an XR client.

Furthermore, this application describes how to provide different representations of scene objects targeting several renderers/computation modules/computation blocks within a scene graph structure. This application also describes how to delegate based on the User Equipment capabilities.

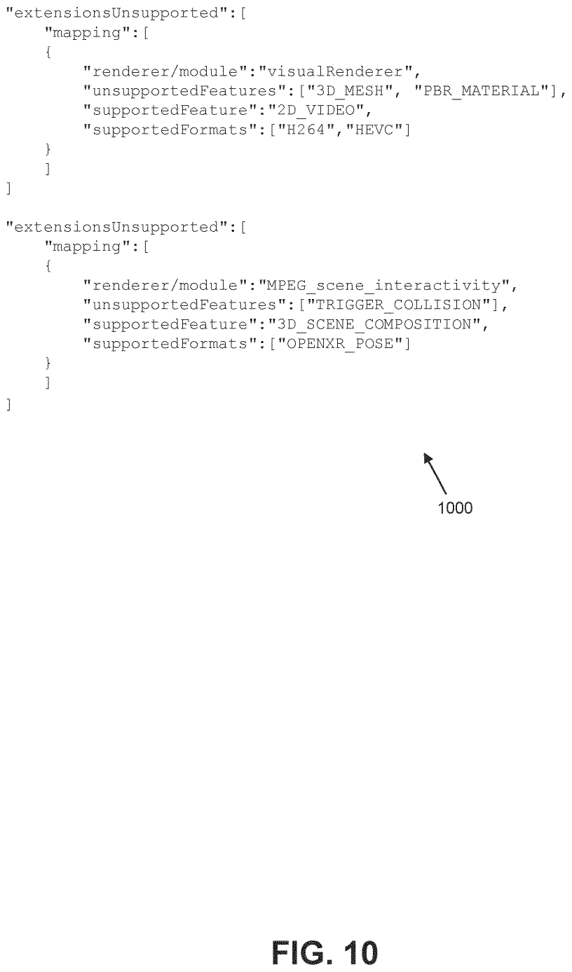

FIG. 10 is a code listing for example mappings of delegated renderers/computation modules according to some embodiments. In the case of a gITF-based scene description, the mapping between the supported feature and format(s) and the related delegated renderers/computation modules may be provided in the new “extensionsUnsupported” section as shown in the code listing 1000 of FIG. 10.

The following two use cases are illustrated in FIG. 10: (1) when the 3D mesh and Physically-Based Rendering (PBR) material are not supported, leading to a delegation of the visual rendering to an Edge Application Server (EAS); and (2) when the collision handling is not supported, which may lead to a delegation of the scene interactivity computation (including for instance the collision and physics simulation) to an Edge Application Server (EAS).

For some embodiments, when the 3D mesh and Physically-Based Rendering (PBR) material are not supported, leading to delegate the visual rendering to the Edge Application Server, the supported feature is the decoding of a 2D video corresponding to the rendered stream; and the supported format of the 2D video shall either be H.264 or HEVC to be successfully processed by the User Equipment.

For some embodiments, when the collision handling is not supported, leading to delegate the scene interactivity computation (including for instance the collision and physics simulation) to the Edge Application Server, the supported feature is the 3D scene composition; and the pose of each 3D object issued from the delegated interactivity computation (including for instance collision and physics simulation) shall be expressed in the OpenXR pose format to be processed by the User Equipment for further rendering (such as visual rendering).

Khronos' OpenXR XrPosef format structure, which is described in The OpenXR Specification, Khronos OpenXR Working Group (Version 1.0.27), available at registry<dot>khronos<dot>org/openxr/specs/1.0/html/xrspec<dot>html # XrPsoef, is composed of a quaternion for the orientation and a vector3 for the position.

For some embodiments, detection of ideas presented in this application may be detected via the use of the dedicated semantic in the MPEG-I SD standard and/or by detecting the call/function flow related to the EDGAR-based User Equipment (UE) capabilities in the 3 GPP SA4 specification.

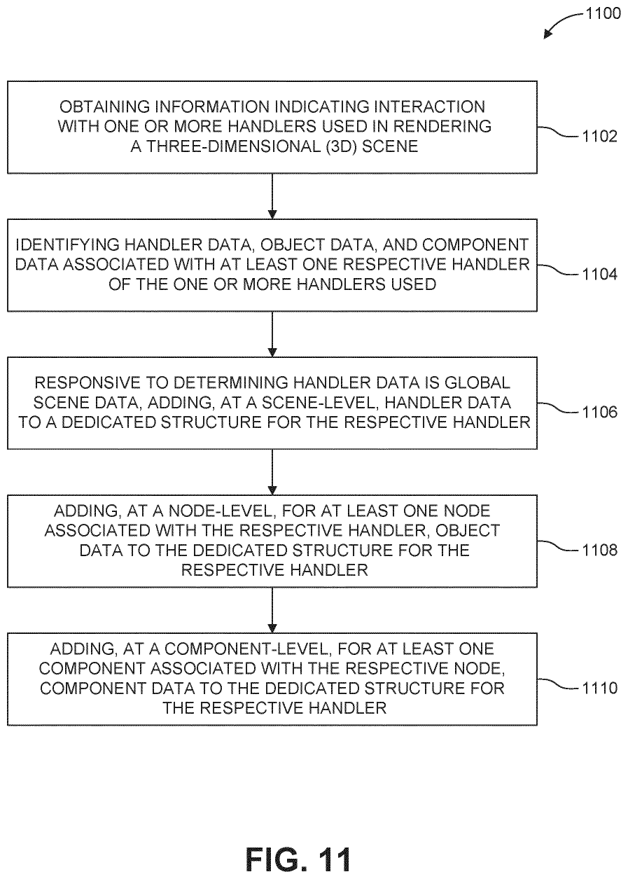

FIG. 11 is a flowchart illustrating an example process for generating a single shared scene graph according to some embodiments. For some embodiments, an example process 1100 may include obtaining 1102 information indicating interaction with one or more handlers used in processing a three-dimensional (3D) scene. Some embodiments of the example process may further include identifying 1104 handler data, object data, and component data associated with at least one respective handler of the one or more renderers used. For some embodiments, the example process may further include responsive to determining 1106 handler data is global scene data, adding, at a scene-level, handler data to a dedicated structure for the respective handler. Some embodiments of the example process may further include adding 1108, at a node-level, for at least one node associated with the respective handler, object data to the dedicated structure for the respective handler. For some embodiments, the example process may further include adding 1110, at a component-level, for at least one component associated with the respective node, component data to the dedicated structure for the respective handler.

While the methods and systems in accordance with some embodiments are generally discussed in context of extended reality (XR), some embodiments may be applied to any XR contexts such as, e.g., virtual reality (VR)/mixed reality (MR)/augmented reality (AR) contexts. Also, although the term “head mounted display (HMD)” is used herein in accordance with some embodiments, some embodiments may be applied to a wearable device (which may or may not be attached to the head) capable of, e.g., XR, VR, AR, and/or MR for some embodiments.

A first example method in accordance with some embodiments may include: obtaining information indicating interaction with one or more renderers used in rendering a three-dimensional (3D) scene; identifying renderer data, object data, and component data associated with at least one respective renderer of the one or more renderers used; responsive to determining renderer data is global scene data, adding, at a scene-level, renderer data to a dedicated structure for the respective renderer; adding, at a node-level, for at least one node associated with the respective renderer, object data to the dedicated structure for the respective renderer; and adding, at a component-level, for at least one component associated with the respective node, component data to the dedicated structure for the respective renderer.

For some embodiments of the first example method, the one or more renderers are selected from the group consisting of video-related renderers, audio-related renderers, and haptic-related renderers.

For some embodiments of the first example method, the one or more renderers are selected from the group consisting of video-related renderers, audio-related renderers, haptic-related renderers, geometric-related renderers, texture-related renderers, camera-related renderers, animation-related renderers, physics-related renderers, and lighting-related renderers.

For some embodiments of the first example method, at least two renderers are used in rendering the 3D scene, and at least two categories of renderers are selected from the group consisting of video-related renderers, audio-related renderers, haptic-related renderers, geometric-related renderers, texture-related renderers, camera-related renderers, animation-related renderers, physics-related renderers, and lighting-related renderers.

For some embodiments of the first example method, at least one of the dedicated structures is compatible with a gITF format.

For some embodiments of the first example method, at least one of the dedicated structures is compatible with an MPEG-I Scene Description format.

For some embodiments of the first example method, the dedicated structures are stored in a single file.

For some embodiments of the first example method, the renderer data includes functionality support information.

For some embodiments of the first example method, the functionality support information includes renderer functionality needed to render at least one component of an object.

For some embodiments of the first example method, the component data for at least one component includes information indicating an ability to render the scene in a degraded mode without rendering the at least one component.

A first example apparatus in accordance with some embodiments may include: a processor; and a non-transitory computer-readable medium storing instructions operative, when executed by the processor, to cause the apparatus to perform any of the methods listed above.

A second example method in accordance with some embodiments may include: obtaining information indicating interaction with one or more renderers used in rendering a three-dimensional (3D) scene; identifying renderer data, object data, and component data associated with at least one respective renderer of the one or more renderers used; obtaining, at a scene-level, renderer data from a dedicated structure for the respective renderer; obtaining, at a node-level, for at least one node associated with the respective renderer, object data from the dedicated structure for the respective renderer; obtaining, at a component-level, for at least one component associated with the respective node, component data from the dedicated structure for the respective renderer; and determining renderer support for the respective renderer.

For some embodiments of the second example method, determining renderer support includes: verifying user equipment (UE) supports the respective renderer; obtaining rendering data associated with the respective renderer; and rendering at least one component associated with the rendering data.

For some embodiments of the second example method, determining renderer support includes: determining user equipment (UE) lacks support for the respective renderer; sending, to an edge server, rendering data associated with the respective renderer; and verifying the edge server accepted delegation of the rendering data.

For some embodiments of the second example method, determining renderer support includes: determining user equipment (UE) lacks support for the respective renderer; sending, to an edge server, rendering data associated with the respective renderer; determining the edge server declined delegation of the rendering data; and responsive to determining rendering of the rendering data is not required, continuing to use the 3D scene without rendering the rendering data.

For some embodiments of the second example method, determining renderer support includes: determining user equipment (UE) lacks support for the respective renderer; sending, to an edge server, rendering data associated with the respective renderer; determining the edge server declined delegation of the rendering data; and responsive to determining rendering of the rendering data is required, generating an error message; and stopping use of the 3D scene without rendering the rendering data.

For some embodiments of the second example method, the one or more renderers are selected from the group consisting of video-related renderers, audio-related renderers, and haptic-related renderers.

For some embodiments of the second example method, the one or more renderers are selected from the group consisting of video-related renderers, audio-related renderers, haptic-related renderers, geometric-related renderers, texture-related renderers, camera-related renderers, animation-related renderers, physics-related renderers, and lighting-related renderers.

For some embodiments of the second example method, at least two renderers are used in rendering the 3D scene, and at least two categories of renderers are selected from the group consisting of video-related renderers, audio-related renderers, haptic-related renderers, geometric-related renderers, texture-related renderers, camera-related renderers, animation-related renderers, physics-related renderers, and lighting-related renderers.

For some embodiments of the second example method, at least one of the dedicated structures is compatible with a gITF format.

For some embodiments of the second example method, at least one of the dedicated structures is compatible with an MPEG-I Scene Description format.

For some embodiments of the second example method, the dedicated structures are stored in a single file.

A second example apparatus in accordance with some embodiments may include: a processor; and a non-transitory computer-readable medium storing instructions operative, when executed by the processor, to cause the apparatus to perform any of the methods listed above.

A third example method in accordance with some embodiments may include: obtaining information indicating interaction with one or more computation blocks used in generating a three-dimensional (3D) scene; identifying computation block data, object data, and component data associated with at least one respective computation block of the one or more computation blocks used; responsive to determining computation block data is global scene data, adding, at a scene-level, computation block data to a dedicated structure for the respective computation block; adding, at a node-level, for at least one node associated with the respective computation block, object data to the dedicated structure for the respective computation block; and adding, at a component-level, for at least one component associated with the respective node, component data to the dedicated structure for the respective computation block.

For some embodiments of the third example method, the one or more computation blocks are selected from the group consisting of video-related computation blocks, audio-related computation blocks, haptic-related computation blocks, geometric-related computation blocks, texture-related computation blocks, camera-related computation blocks, animation-related computation blocks, physics-related computation blocks, and lighting-related computation blocks.

For some embodiments of the third example method, at least two computation blocks are used in performing a computation related to the 3D scene, and at least two categories of computation blocks are selected from the group consisting of video-related computation blocks, audio-related computation blocks, haptic-related computation blocks, geometric-related computation blocks, texture-related computation blocks, camera-related computation blocks, animation-related computation blocks, physics-related computation blocks, and lighting-related computation blocks.

For some embodiments of the third example method, at least one of the dedicated structures is compatible with a gITF format.

For some embodiments of the third example method, at least one of the dedicated structures is compatible with an MPEG-I Scene Description format.

For some embodiments of the third example method, the dedicated structures are stored in a single file.

For some embodiments of the third example method, the computation block data includes functionality support information.

For some embodiments of the third example method, the functionality support information includes computation block functionality needed to perform a calculation for at least one component of an object.

For some embodiments of the third example method, the component data for at least one component includes information indicating an ability to generate the scene in a degraded mode without performing a calculation related to the at least one component.

A third example apparatus in accordance with some embodiments may include: a processor; and a non-transitory computer-readable medium storing instructions operative, when executed by the processor, to cause the apparatus to perform any of the methods listed above.

A fourth example method in accordance with some embodiments may include: obtaining information indicating interaction with one or more computation blocks used in generating a three-dimensional (3D) scene; identifying computation block data, object data, and component data associated with at least one respective computation block of the one or more computation blocks used; obtaining, at a scene-level, computation block data from a dedicated structure for the respective computation block; obtaining, at a node-level, for at least one node associated with the respective computation block, object data from the dedicated structure for the respective computation block; obtaining, at a component-level, for at least one component associated with the respective node, component data from the dedicated structure for the respective computation block; and determining computation block support for the respective computation block.

For some embodiments of the fourth example method, determining computation block support includes: verifying user equipment (UE) supports the respective computation block; obtaining computation block data associated with the respective computation block; and computing a calculation related to at least one component associated with the computation block data.

For some embodiments of the fourth example method, determining computation block support includes: determining user equipment (UE) lacks support for the respective computation block; sending, to an edge server, computation block data associated with the respective computation block; and verifying the edge server accepted delegation of the computation block data.

For some embodiments of the fourth example method, determining computation block support includes: determining user equipment (UE) lacks support for the respective computation block; sending, to an edge server, computation block data associated with the respective computation block; determining the edge server declined delegation of the computation block data; and responsive to determining performing a calculation related to the computation block data is not required, continuing to use the 3D scene without performing the calculation related to a component.

For some embodiments of the fourth example method, determining computation block support includes: determining user equipment (UE) lacks support for the respective computation block; sending, to an edge server, computation block data associated with the respective computation block; determining the edge server declined delegation of the computation block data; and responsive to determining computation of the computation block data is required, generating an error message; and stopping use of the 3D scene without performing the calculation related to a component.

For some embodiments of the fourth example method, the one or more computation blocks are selected from the group consisting of video-related computation blocks, audio-related computation blocks, haptic-related computation blocks, geometric-related computation blocks, texture-related computation blocks, camera-related computation blocks, animation-related computation blocks, physics-related computation blocks, and lighting-related computation blocks.

For some embodiments of the fourth example method, at least two computation blocks are used in generating the 3D scene, and at least two categories of computation blocks are selected from the group consisting of video-related computation blocks, audio-related computation blocks, haptic-related computation blocks, geometric-related computation blocks, texture-related computation blocks, camera-related computation blocks, animation-related computation blocks, physics-related computation blocks, and lighting-related computation blocks.

For some embodiments of the fourth example method, at least one of the dedicated structures is compatible with a gITF format.

For some embodiments of the fourth example method, at least one of the dedicated structures is compatible with an MPEG-I Scene Description format.

For some embodiments of the fourth example method, the dedicated structures are stored in a single file.

For some embodiments of the fourth example method, the single file includes two or more versions of object data.

For some embodiments of the fourth example method, the single file includes two or more versions of component data.

For some embodiments of the fourth example method, at least two computation blocks are used in generating the 3D scene, first and second categories of computation blocks are selected from the group consisting of video-related computation blocks, audio-related computation blocks, haptic-related computation blocks, geometric-related computation blocks, texture-related computation blocks, camera-related computation blocks, animation-related computation blocks, physics-related computation blocks, and lighting-related computation blocks, the first category is different from the second category, the single file includes first and second versions of object data, the first version of the object data is associated with the first category of computation blocks, and the second version of the object data is associated with the second category of computation blocks.

For some embodiments of the fourth example method, at least two computation blocks are used in generating the 3D scene, first and second categories of computation blocks are selected from the group consisting of video-related computation blocks, audio-related computation blocks, haptic-related computation blocks, geometric-related computation blocks, texture-related computation blocks, camera-related computation blocks, animation-related computation blocks, physics-related computation blocks, and lighting-related computation blocks, the first category is different from the second category, the single file includes first and second versions of component data, the first version of the component data is associated with the first category of computation blocks, and the second version of the component data is associated with the second category of computation blocks.

A fourth example apparatus in accordance with some embodiments may include: a processor; and a non-transitory computer-readable medium storing instructions operative, when executed by the processor, to cause the apparatus to perform any of the methods listed above.

A fifth example method in accordance with some embodiments may include: obtaining information indicating interaction with one or more handlers used in processing a three-dimensional (3D) scene; identifying handler data, object data, and component data associated with at least one respective handler of the one or more handlers used; obtaining, at a scene-level, handler data from a dedicated structure for the respective handler; obtaining, at a node-level, for at least one node associated with the respective handler, object data from the dedicated structure for the respective handler; obtaining, at a component-level, for at least one component associated with the respective node, component data from the dedicated structure for the respective handler; and determining handler support for the respective handler.

For some embodiments of the fifth example method, the one or more handlers include one or more renderers.

For some embodiments of the fifth example method, the one or more handlers include one or more computation blocks.

For some embodiments of the fifth example method, the one or more handlers include one or more renderers and one or more computation blocks.

A sixth example method in accordance with some embodiments may include: obtaining information indicating interaction with a handler used in processing a three-dimensional (3D) scene; obtaining handler data, object data, and component data from a dedicated structure for the handler; determining handler support for the handler; and responsive to determining handler support indicates local support, processing, via the handler, at least one of the handler data, the object data, and the component data.

A seventh example method in accordance with some embodiments may include: obtaining information indicating interaction with a handler used in processing a three-dimensional (3D) scene; obtaining handler data, object data, and component data from a dedicated structure for the handler; determining handler support for the handler; and responsive to determining handler support indicates delegation, sending, to a delegation device, at least one of the handler data, the object data, and the component data.

An eighth example method in accordance with some embodiments may include: obtaining information indicating interaction with one or more handlers used in processing a three-dimensional (3D) scene; identifying handler data, object data, and component data associated with at least one respective handler of the one or more handlers used; responsive to determining handler data is global scene data, adding, at a scene-level, handler data to a dedicated structure for the respective handler; adding, at a node-level, for at least one node associated with the respective renderer, object data to the dedicated structure for the respective handler; and adding, at a component-level, for at least one component associated with the respective node, component data to the dedicated structure for the respective handler.

For some embodiments of the eighth example method, one or more handlers include one or more renderers.

For some embodiments of the eighth example method, one or more handlers include one or more computation blocks.

For some embodiments of the eighth example method, one or more handlers include one or more renderers and one or more computation blocks.

A ninth example method in accordance with some embodiments may include: obtaining information corresponding to a scene description associated with a single node graph; and adding, to a dedicated structure, renderer data, object data, and component data associated with each of at least two respective renderers, wherein the dedicated structure comprises two or more representations of an object in a scene associated with the scene description.

For some embodiments of the ninth example method, the dedicated structure is compatible with a gITF format.

For some embodiments of the ninth example method, the dedicated structure is compatible with an MPEG-I Scene Description format.

For some embodiments of the ninth example method, the dedicated structure is stored in a single file.

For some embodiments of the ninth example method, at least one of the two or more representations of the object comprises mesh geometries of the object.

For some embodiments of the ninth example method, the dedicated structure comprises a data memory structure.

A ninth example apparatus in accordance with some embodiments may include: a processor; and a non-transitory computer-readable medium storing instructions operative, when executed by the processor, to cause the apparatus to perform any one of the methods listed above.

An example method in accordance with some embodiments may include: obtaining information indicating interaction with one or more renderers used in rendering a three-dimensional (3D) scene; identifying renderer data, object data, and component data associated with at least one respective renderer of the one or more renderers used; responsive to determining renderer data is global scene data, adding, at a scene-level, renderer data to a dedicated structure for the respective renderer; adding, at a node-level, for at least one node associated with the respective renderer, object data to the dedicated structure for the respective renderer; and adding, at a component-level, for at least one component associated with the respective node, component data to the dedicated structure for the respective renderer.

For some embodiments of the example method, the one or more renderers are selected from the group consisting of video-related renderers, audio-related renderers, and haptic-related renderers.

For some embodiments of the example method, the one or more renderers are selected from the group consisting of video-related renderers, audio-related renderers, haptic-related renderers, geometric-related renderers, texture-related renderers, camera-related renderers, animation-related renderers, physics-related renderers, and lighting-related renderers.

For some embodiments of the example method, at least two renderers are used in rendering the 3D scene, and at least two categories of renderers are selected from the group consisting of video-related renderers, audio-related renderers, haptic-related renderers, geometric-related renderers, texture-related renderers, camera-related renderers, animation-related renderers, physics-related renderers, and lighting-related renderers.

For some embodiments of the example method, at least one of the dedicated structures is compatible with a gITF format.

For some embodiments of the example method, at least one of the dedicated structures is compatible with an MPEG-I Scene Description format.

For some embodiments of the example method, the dedicated structures are stored in a single file.

For some embodiments of the example method, the renderer data includes functionality support information.

For some embodiments of the example method, the functionality support information includes renderer functionality needed to render at least one component of an object.

For some embodiments of the example method, the component data for at least one component includes information indicating an ability to render the scene in a degraded mode without rendering the at least one component.

An example apparatus in accordance with some embodiments may include: a processor; and a non-transitory computer-readable medium storing instructions operative, when executed by the processor, to cause the apparatus to perform any one of the methods listed above.

An additional example method in accordance with some embodiments may include: obtaining information indicating interaction with one or more renderers used in rendering a three-dimensional (3D) scene; obtaining, at a scene-level, renderer data from a dedicated structure for the respective renderer; obtaining, at a node-level, for at least one node associated with the respective renderer, object data from the dedicated structure for the respective renderer; obtaining, at a component-level, for at least one component associated with the respective node, component data from the dedicated structure for the respective renderer; and determining renderer support for at least one of the one or more renderers.

For some embodiments of the additional example method, determining renderer support may include: verifying user equipment (UE) supports the respective renderer; obtaining rendering data associated with the respective renderer; and rendering at least one component associated with the rendering data.

For some embodiments of the additional example method, determining renderer support may include: determining user equipment (UE) lacks support for the respective renderer; sending, to an edge server, rendering data associated with the respective renderer; and verifying the edge server accepted delegation of the rendering data.

For some embodiments of the additional example method, determining renderer support may include: determining user equipment (UE) lacks support for the respective renderer; sending, to an edge server, rendering data associated with the respective renderer; determining the edge server declined delegation of the rendering data; and responsive to determining rendering of the rendering data is not required, continuing to use the 3D scene without rendering the rendering data.

For some embodiments of the additional example method, determining renderer support may include: determining user equipment (UE) lacks support for the respective renderer; sending, to an edge server, rendering data associated with the respective renderer; determining the edge server declined delegation of the rendering data; and responsive to determining rendering of the rendering data is required, generating an error message; and stopping use of the 3D scene without rendering the rendering data.

For some embodiments of the additional example method, the one or more renderers are selected from the group consisting of video-related renderers, audio-related renderers, and haptic-related renderers.

For some embodiments of the additional example method, the one or more renderers are selected from the group consisting of video-related renderers, audio-related renderers, haptic-related renderers, geometric-related renderers, texture-related renderers, camera-related renderers, animation-related renderers, physics-related renderers, and lighting-related renderers.

For some embodiments of the additional example method, at least two renderers are used in rendering the 3D scene, and at least two categories of renderers are selected from the group consisting of video-related renderers, audio-related renderers, haptic-related renderers, geometric-related renderers, texture-related renderers, camera-related renderers, animation-related renderers, physics-related renderers, and lighting-related renderers.

For some embodiments of the additional example method, at least one of the dedicated structures is compatible with a gITF format.

For some embodiments of the additional example method, at least one of the dedicated structures is compatible with an MPEG-I Scene Description format.

For some embodiments of the additional example method, the dedicated structures are stored in a single file.

An additional example apparatus in accordance with some embodiments may include: a processor; and a non-transitory computer-readable medium storing instructions operative, when executed by the processor, to cause the apparatus to perform any one of the methods listed above.

A further example method in accordance with some embodiments may include: obtaining information indicating interaction with one or more computation blocks used in generating a three-dimensional (3D) scene; identifying computation block data, object data, and component data associated with at least one respective computation block of the one or more computation blocks used; responsive to determining computation block data is global scene data, adding, at a scene-level, computation block data to a dedicated structure for the respective computation block; adding, at a node-level, for at least one node associated with the respective computation block, object data to the dedicated structure for the respective computation block; and adding, at a component-level, for at least one component associated with the respective node, component data to the dedicated structure for the respective computation block.

For some embodiments of the further example method, the one or more computation blocks are selected from the group consisting of video-related computation blocks, audio-related computation blocks, haptic-related computation blocks, geometric-related computation blocks, texture-related computation blocks, camera-related computation blocks, animation-related computation blocks, physics-related computation blocks, and lighting-related computation blocks.

For some embodiments of the further example method, at least two computation blocks are used in performing a computation related to the 3D scene, and at least two categories of computation blocks are selected from the group consisting of video-related computation blocks, audio-related computation blocks, haptic-related computation blocks, geometric-related computation blocks, texture-related computation blocks, camera-related computation blocks, animation-related computation blocks, physics-related computation blocks, and lighting-related computation blocks.

For some embodiments of the further example method, at least one of the dedicated structures is compatible with a gITF format.

For some embodiments of the further example method, at least one of the dedicated structures is compatible with an MPEG-I Scene Description format.

For some embodiments of the further example method, the dedicated structures are stored in a single file.

For some embodiments of the further example method, the computation block data includes functionality support information.

For some embodiments of the further example method, the functionality support information includes computation block functionality needed to perform a calculation for at least one component of an object.

For some embodiments of the further example method, the component data for at least one component includes information indicating an ability to generate the scene in a degraded mode without performing a calculation related to the at least one component.

A further example apparatus in accordance with some embodiments may include: a processor; and a non-transitory computer-readable medium storing instructions operative, when executed by the processor, to cause the apparatus to perform any one of the methods listed above.

A further additional example method in accordance with some embodiments may include: obtaining information indicating interaction with one or more computation blocks used in generating a three-dimensional (3D) scene; obtaining, at a scene-level, computation block data from a dedicated structure for the respective computation block; obtaining, at a node-level, for at least one node associated with the respective computation block, object data from the dedicated structure for the respective computation block; obtaining, at a component-level, for at least one component associated with the respective node, component data from the dedicated structure for the respective computation block; and determining computation block support for at least one of the one or more computation blocks.

For some embodiments of the further additional example method, determining computation block support may include: verifying user equipment (UE) supports the respective computation block; obtaining computation block data associated with the respective computation block; and computing a calculation related to at least one component associated with the computation block data.

For some embodiments of the further additional example method, determining computation block support may include: determining user equipment (UE) lacks support for the respective computation block; sending, to an edge server, computation block data associated with the respective computation block; and verifying the edge server accepted delegation of the computation block data.

For some embodiments of the further additional example method, determining computation block support may include: determining user equipment (UE) lacks support for the respective computation block; sending, to an edge server, computation block data associated with the respective computation block; determining the edge server declined delegation of the computation block data; and responsive to determining performing a calculation related to the computation block data is not required, continuing to use the 3D scene without performing the calculation related to a component.

For some embodiments of the further additional example method, determining computation block support may include: determining user equipment (UE) lacks support for the respective computation block; sending, to an edge server, computation block data associated with the respective computation block; determining the edge server declined delegation of the computation block data; and responsive to determining computation of the computation block data is required, generating an error message; and stopping use of the 3D scene without performing the calculation related to a component.

For some embodiments of the further additional example method, the one or more computation blocks are selected from the group consisting of video-related computation blocks, audio-related computation blocks, haptic-related computation blocks, geometric-related computation blocks, texture-related computation blocks, camera-related computation blocks, animation-related computation blocks, physics-related computation blocks, and lighting-related computation blocks.

For some embodiments of the further additional example method, at least two computation blocks are used in generating the 3D scene, and at least two categories of computation blocks are selected from the group consisting of video-related computation blocks, audio-related computation blocks, haptic-related computation blocks, geometric-related computation blocks, texture-related computation blocks, camera-related computation blocks, animation-related computation blocks, physics-related computation blocks, and lighting-related computation blocks.

For some embodiments of the further additional example method, at least one of the dedicated structures is compatible with a gITF format.

For some embodiments of the further additional example method, at least one of the dedicated structures is compatible with an MPEG-I Scene Description format.

For some embodiments of the further additional example method, the dedicated structures are stored in a single file.

For some embodiments of the further additional example method, the single file may include two or more versions of object data.

For some embodiments of the further additional example method, the single file may include two or more versions of component data.

For some embodiments of the further additional example method, at least two computation blocks are used in generating the 3D scene, the first and second categories of computation blocks are selected from the group consisting of video-related computation blocks, audio-related computation blocks, haptic-related computation blocks, geometric-related computation blocks, texture-related computation blocks, camera-related computation blocks, animation-related computation blocks, physics-related computation blocks, and lighting-related computation blocks, the first category is different from the second category, the single file includes first and second versions of object data, the first version of the object data is associated with the first category of computation blocks, and the second version of the object data is associated with the second category of computation blocks.

For some embodiments of the further additional example method, at least two computation blocks are used in generating the 3D scene, first and second categories of computation blocks are selected from the group consisting of video-related computation blocks, audio-related computation blocks, haptic-related computation blocks, geometric-related computation blocks, texture-related computation blocks, camera-related computation blocks, animation-related computation blocks, physics-related computation blocks, and lighting-related computation blocks, the first category is different from the second category, the single file includes first and second versions of component data, the first version of the component data is associated with the first category of computation blocks, and the second version of the component data is associated with the second category of computation blocks.

A further additional example apparatus in accordance with some embodiments may include: a processor; and a non-transitory computer-readable medium storing instructions operative, when executed by the processor, to cause the apparatus to perform any one of the methods listed above.

Another example method in accordance with some embodiments may include: obtaining information indicating interaction with one or more handlers used in processing a three-dimensional (3D) scene; obtaining, at a scene-level, handler data from a dedicated structure for the respective handler; obtaining, at a node-level, for at least one node associated with the respective handler, object data from the dedicated structure for the respective handler; obtaining, at a component-level, for at least one component associated with the respective node, component data from the dedicated structure for the respective handler; and determining handler support for at least one of the one or more handler.

For some embodiments of the another example method, the one or more handlers may include one or more renderers.

For some embodiments of the another example method, the one or more handlers may include one or more computation blocks.

For some embodiments of the another example method, the one or more handlers include one or more renderers and one or more computation blocks.

Yet another example method in accordance with some embodiments may include: obtaining information indicating interaction with a handler used in processing a three-dimensional (3D) scene; obtaining handler data, object data, and component data from a dedicated structure for the handler; determining handler support for the handler; and responsive to determining handler support indicates local support, processing, via the handler, at least one of the handler data, the object data, and the component data.

A yet further another example method in accordance with some embodiments may include: obtaining information indicating interaction with a handler used in processing a three-dimensional (3D) scene; obtaining handler data, object data, and component data from a dedicated structure for the handler; determining handler support for the handler; and responsive to determining handler support indicates delegation, sending, to a delegation device, at least one of the handler data, the object data, and the component data.

Note that various hardware elements of one or more of the described embodiments are referred to as “modules” that carry out (i.e., perform, execute, and the like) various functions that are described herein in connection with the respective modules. As used herein, a module includes hardware (e.g., one or more processors, one or more microprocessors, one or more microcontrollers, one or more microchips, one or more application-specific integrated circuits (ASICs), one or more field programmable gate arrays (FPGAs), one or more memory devices) deemed suitable by those of skill in the relevant art for a given implementation. Each described module may also include instructions executable for carrying out the one or more functions described as being carried out by the respective module, and it is noted that those instructions could take the form of or include hardware (i.e., hardwired) instructions, firmware instructions, software instructions, and/or the like, and may be stored in any suitable non-transitory computer-readable medium or media, such as commonly referred to as RAM, ROM, etc.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1-48. (canceled)

49. A method comprising:
obtaining information indicating interaction with two or more handlers used in processing a three-dimensional (3D) scene;
identifying handler data, object data, and component data associated with at least one respective handler of the two or more handlers used;
obtaining, at a scene-level, handler data from a dedicated structure for the respective handler;
obtaining, at a node-level, for at least one node associated with the respective handler, object data from the dedicated structure for the respective handler;
obtaining, at a component-level, for at least one component associated with the respective node, component data from the dedicated structure for the respective handler; and
determining handler support for the respective handler.

50. The method of claim 49, wherein the two or more handlers comprise two or more renderers.

51. The method of claim 49, wherein the two or more handlers comprise one or more computation blocks.

52. The method of claim 49, wherein the two or more handlers comprise one or more renderers and one or more computation blocks.

53-54. (canceled)

55. A method comprising:
obtaining information indicating interaction with two or more handlers used in processing a three-dimensional (3D) scene;
identifying handler data, object data, and component data associated with at least one respective handler of the two or more handlers used;
responsive to determining handler data is global scene data, adding, at a scene-level, handler data to a dedicated structure for the respective handler;
adding, at a node-level, for at least one node associated with the respective handler, object data to the dedicated structure for the respective handler; and
adding, at a component-level, for at least one component associated with the respective node, component data to the dedicated structure for the respective handler.

56. The method of claim 55, wherein two or more handlers comprise one two or more renderers.

57. The method of claim 55, wherein two or more handlers comprise one or more computation blocks.

58. The method of claim 55, wherein two or more handlers comprise one or more renderers and one or more computation blocks.

59-65. (canceled)

66. The method of claim 55, wherein the dedicated structure is compatible with at least one of a gITF format and an MPEG-I Scene Description format.

67. The method of claim 49, wherein the information and the scene description are associated with a single node graph.

68. The method of claim 67, wherein determining handler support comprises:
verifying user equipment (UE) supports the respective handler;
obtaining rendering data associated with the respective handler; and
rendering at least one component associated with the rendering data.

69. The method of claim 67, wherein determining handler support comprises:
determining user equipment (UE) lacks support for the respective handler;
sending, to an edge server, rendering data associated with the respective handler; and
verifying the edge server accepted delegation of the rendering data.

70. The method of claim 67, wherein determining handler support comprises:
determining user equipment (UE) lacks support for the respective handler;
sending, to an edge server, rendering data associated with the respective handler;
determining the edge server declined delegation of the rendering data; and
responsive to determining rendering of the rendering data is not required, continuing to use the 3D scene without rendering the rendering data.

71. The method of claim 67, wherein determining handler support comprises:
determining user equipment (UE) lacks support for the respective handler;
sending, to an edge server, rendering data associated with the respective handler;
determining the edge server declined delegation of the rendering data; and
responsive to determining rendering of the rendering data is required, generating an error message; and
stopping use of the 3D scene without rendering the rendering data.

72. The method of claim 49, wherein the two or more handlers are selected from the group consisting of video-related handlers, audio-related handlers, and haptic-related handlers.

73. The method of claim 49, wherein the two or more handlers are selected from the group consisting of video-related handlers, audio-related handlers, haptic-related handlers, geometric-related handlers, texture-related handlers, camera-related handlers, animation-related handlers, physics-related handlers, and lighting-related handlers.

74. The method of claim 49, wherein at least one of the dedicated structures is compatible with a glTF format.

75. The method of claim 49, wherein at least one of the dedicated structures is compatible with an MPEG-I Scene Description format.

76. The method of claim 49, wherein the dedicated structures are stored in a single file.

77. An apparatus comprising:
a processor; and
a non-transitory computer-readable medium storing instructions operative, when executed by the processor, to cause the apparatus to:
obtain information indicating interaction with two or more handlers used in processing a three-dimensional (3D) scene;
identify handler data, object data, and component data associated with at least one respective handler of the two or more handlers used;
obtain, at a scene-level, handler data from a dedicated structure for the respective handler;
obtain, at a node-level, for at least one node associated with the respective handler, object data from the dedicated structure for the respective handler;
obtain, at a component-level, for at least one component associated with the respective node, component data from the dedicated structure for the respective handler; and
determine handler support for the respective handler.
